(19) United States
(12) Patent Application Publication
(10) Pub. No.: US 2025/0070840 A1
(43) Pub. Date: Feb. 27, 2025

(54) APPARATUS AND METHOD FOR PREDICTING CHANNEL ON BASIS OF COMPRESSED CHANNEL STATE INFORMATION FEEDBACK IN WIRELESS COMMUNICATION SYSTEM

(71) Applicant: Samsung Electronics Co., Ltd., Suwon-si (KR)

(72) Inventors: Younghyun JEON, Suwon-si (KR); Seokju JANG, Suwon-si (KR)

(21) Appl. No.: 18/943,554

(22) Filed: Nov. 11, 2024

Related U.S. Application Data
(63) Continuation of application No. PCT/KR2023/006077, filed on May 3, 2023.

(30) Foreign Application Priority Data
May 11, 2022 (KR) 10-2022-0057953
Mar. 9, 2023 (KR) 10-2023-0031409

(51) Int. Cl. H04B 7/06; H04B 7/0456; H04W 72/044

(52) U.S. Cl. CPC H04B 7/0626; H04B 7/0456; H04W 72/044

(57) ABSTRACT

The disclosure relates to a 5G or 6G communication system for supporting a higher data transmission rate. According to various embodiments of the present disclosure, a method performed by a base station in a wireless communication system may comprise: acquiring, on the basis of a CSI report in a first time period, channel information including current channel state information (CSI) from a terminal; identifying, on the basis of the channel information, a spatial domain (SD) component, a frequency domain (FD) component, and a linear combination (LC) coefficient value mapped to the SD component and the FD component used for compression; acquiring a filtered LC coefficient value on the basis of a Kalman filter, and generating predicted channel information in a second time period on the basis of the SD component, the FD component, and the filtered LC coefficient value.

### CROSS-REFERENCE TO RELATED APPLICATIONS

This application is a continuation of International Application No. PCT/KR2023/006077 designating the United States, filed on May 3, 2023, in the Korean Intellectual Property Receiving Office and claiming priority to Korean Patent Application Nos. 10-2022-0057953, filed on May 11, 2022, and 10-2023-0031409, filed on Mar. 9, 2023, in the Korean Intellectual Property Office, the disclosures of each of which are incorporated by reference herein in their entireties.

### BACKGROUND

### Field

The disclosure relates to a wireless communication system and, for example, to a device and a method for efficiently performing channel prediction using a Kalman filter, based on a compressed channel information feedback structure reported by a terminal in a wireless communication system.

### Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, JAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

Embodiments of the disclosure provide a device and a method for predicting a channel parameter in a wireless communication system.

Embodiments of the disclosure provide a device and a method for predicting channel information at low complexity by performing linear prediction, based on a space basis, a frequency basis, and a channel coefficient obtained from compressed channel information feedback (e.g., compressed channel state information (CSI) feedback) or a channel information compression structure (CSI compression structure) of a terminal in a wireless communication system.

Embodiments of the disclosure provide a device and a method for more correctly estimating a channel by extracting a channel parameter having a low dimensionality from compressed channel information feedback of a terminal, then additionally extracting a channel parameter required for prediction, based on a Kalman filter, and reconstructing a predicted channel, based on a predicted channel parameter.

Embodiments of the disclosure provide a device and a method for estimating a channel at low complexity in a wireless communication system.

According to various example embodiments of the disclosure, a method performed by a base station in a wireless communication system may include: obtaining, from a terminal, channel information including current channel state information, based on a channel state information (CSI) report in a first time interval, identifying, based on the channel information, a spatial domain (SD) component, a frequency domain (FD) component, and a linear combination (LC) coefficient value mapped to the SD component and the FD component having been used for compression, obtaining a filtered LC coefficient value, based on a Kalman filter, and generating predicted channel information in a second time interval, based on the SD component, the FD component, and the filtered LC coefficient value.

According to various example embodiments of the disclosure, a base station in a wireless communication system may include: at least one transceiver, and a controller coupled to the at least one transceiver, wherein the controller is configured to: obtain, from a terminal, channel information including current channel state information, based on a channel state information (CSI) report in a first time interval, identify, based on the channel information, a spatial domain (SD) component, a frequency domain (FD) component, and a linear combination (LC) coefficient value mapped to the SD component and the FD component having been used for compression, obtain a filtered LC coefficient value, based on a Kalman filter, and generate predicted channel information in a second time interval, based on the SD component, the FD component, and the filtered LC coefficient value.

By a device and a method according to various example embodiments of the disclosure, when a terminal reports compressed channel information (compressed CSI feedback) to a base station, the base station applies parsing to the CSI feedback to calculate an SD/FD basis component and a low-dimensional channel coefficient mapped thereto, applies a Kalman filter technique to the calculated channel coefficient to predict a channel coefficient of a next time or extract a channel parameter required for channel prediction, and reconstructs a predicted channel based on the predicted channel coefficient or channel parameter, so that channel prediction at low complexity is possible.

By a device and a method according to various example embodiments of the disclosure, channel parameters are parsed and predicted based on a Kalman filter, thereby enabling more accurate channel estimation with low complexity.

Advantageous effects obtainable from the disclosure may not be limited to the above-mentioned effects, and other effects which are not mentioned may be clearly understood from the following descriptions by those skilled in the art to which the disclosure pertains.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example wireless communication system according to various embodiments;

FIG. 2 is a block diagram illustrating an example configuration of a base station in a wireless communication system according to various embodiments;

FIG. 3 is a block diagram illustrating an example configuration of a UE in a wireless communication system according to various embodiments;

FIG. 4 is a block diagram illustrating an example configuration of a communication unit in a wireless communication system according to various embodiments;

FIG. 5 is a diagram illustrating an example resource structure of a time-frequency domain in a wireless communication system according to various embodiments;

FIG. 6 is a diagram illustrating an example for generating channel information based on a linear combination codebook according to various embodiments;

FIG. 7 is a diagram illustrating an example of a codebook matrix based on a spatial domain and a frequency domain according to various embodiments;

FIG. 8 is a diagram illustrating an example of a system model in a wireless communication system according to various embodiments;

FIG. 9 is a diagram illustrating an example operation for estimating a channel, based on a Kalman filter according to various embodiments;

FIG. 10 is a diagram illustrating an example of channel prediction based on a Kalman filter according to various embodiments;

FIG. 11 is a diagram illustrating an example operation for predicting a channel at low complexity in a case of a terminal moving at a low speed according to various embodiments;

FIG. 12A is a diagram illustrating an example operation for predicting a channel at low complexity in a case of a terminal moving at a high speed according to various embodiments;

FIG. 12B is a diagram illustrating an example operation for predicting a channel at low complexity in a case of a terminal moving at a high speed according to various embodiments;

FIG. 13 is a diagram illustrating an example operation for predicting a channel, based on a linear Kalman filter (LKF) according to various embodiments;

FIG. 14 is a diagram illustrating an example operation for predicting a channel, based on an extended Kalman filter (EKF) or an unscented Kalman filter (UKF) according to various embodiments;

FIG. 15 is a flowchart illustrating an example operation for estimating a channel using channel state information (CSI) in a wireless communication system according to various embodiments;

FIG. 16 is a flowchart illustrating an example operation for predicting a channel using channel state information (CSI) parsing and a channel parameter according to various embodiments;

FIG. 17 is a diagram illustrating an example operation for performing a channel prediction operation according to various embodiments; and

FIG. 18 is a diagram illustrating an example operation for performing a channel prediction operation according to various embodiments.

### DETAILED DESCRIPTION

The terms used in the disclosure are used merely to describe various example embodiments, and may not be intended to limit the scope of the disclosure. A singular expression may include a plural expression unless they are definitely different in a context. The terms used herein, including technical and scientific terms, may have the same meaning as those commonly understood by a person skilled in the art to which the disclosure pertains. Such terms as those defined in a generally used dictionary may be interpreted to have the meanings equal to the contextual meanings in the relevant field of art, and are not to be interpreted to have ideal or excessively formal meanings unless clearly defined in the disclosure. In some cases, even terms defined in the disclosure should not be interpreted to exclude embodiments of the disclosure.

Hereinafter, various example embodiments of the disclosure will be described based on an approach of hardware. However, various embodiments of the disclosure include a technology that uses both hardware and software, and thus the various embodiments of the disclosure may not exclude the perspective of software.

The disclosure as described below relates to an apparatus and a method for estimating a channel in a wireless communication system. For example, the disclosure relates to an apparatus and a method for estimating a channel based on a Kalman filter that is a type of recursive filter. In addition, the disclosure describes an apparatus and a method for adaptively performing low-complexity channel prediction using a precoding matrix indicator parsing technique and a spatial frequency basis extension model inherent in an enhanced type 2 codebook.

In the following description, terms referring to signals (e.g., message, information, preamble, signaling, sequence, and stream), terms referring to resources (e.g., symbol, slot, subframe, radio frame (RF), subcarrier, resource element (RE), resource block (RB), bandwidth part (BWP), and occasion), terms for operation states (e.g., step, operation, and procedure), terms referring to data (e.g., information, bit, symbol, and codeword), terms referring to channels, terms referring to control information (e.g., downlink control information (DCI), medium access control element (MAC CE), and radio access control (RRC) signaling), terms referring to network entities, terms referring to device elements, and the like are illustratively used for the sake of convenience. Therefore, the disclosure is not limited by the terms as described below, and other terms referring to subjects having equivalent technical meanings may be used.

In the following description, the terms “physical channel” and “signal” may be interchangeably used with the term “data” or “control signal”. For example, the term “physical downlink shared channel (PDSCH)” refers to a physical channel over which data is transmitted, but the PDSCH may also be used to refer to the “data”. For example, in the disclosure, the expression “transmit ting a physical channel” may be understood as having the same meaning as the expression “transmitting data or a signal over a physical channel”.

In the following description, upper signaling may refer to a signal transfer scheme from a base station to a terminal via a downlink data channel of a physical layer, or from a terminal to a base station via an uplink data channel of a physical layer. The upper signaling may also be understood as radio resource control (RRC) signaling or a media access control (MAC) control element (CE).

In the disclosure, the expression “greater than” or “less than” may be used to determine whether a specific condition is satisfied or fulfilled, but this is intended only to illustrate an example and does not exclude “greater than or equal to” or “equal to or less than”. A condition indicated by the expression “greater than or equal to” may be replaced with a condition indicated by “greater than”, a condition indicated by the expression “equal to or less than” may be replaced with a condition indicated by “less than”, and a condition indicated by “greater than and equal to or less than” may be replaced with a condition indicated by “greater than and less than”.

Furthermore, various embodiments of the disclosure will be described using terms used in some communication standards (e.g., the 3rd generation partnership project (3GPP)), but they are for illustrative purposes only. Various embodiments of the disclosure may be easily applied to other communication systems through modifications.

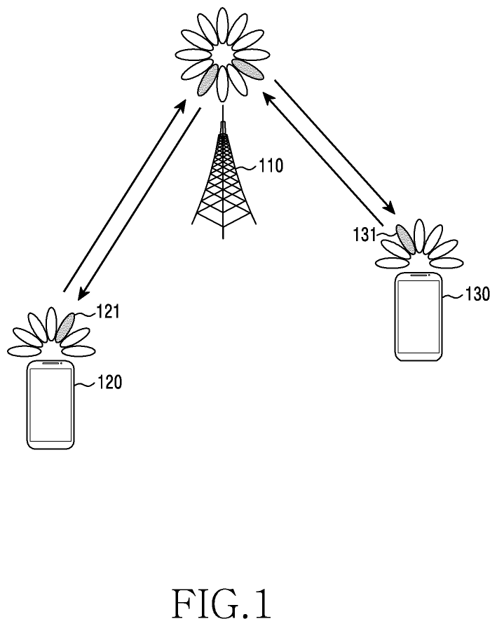

FIG. 1 is a diagram illustrating an example wireless communication system according to various embodiments. FIG. 1 shows an example of a base station 110, a terminal 120, and a terminal 130 as a part of nodes using wireless channels in a wireless communication system. Although FIG. 1 illustrates only one base station, another base station identical to or similar to the base station 110 may be further included.

The base station 110 is a network infrastructure that provides wireless access to the terminals 120 and 130. The base station 110 has a coverage defined as a particular geographic area, based on a distance by which the base station is able to transmit a signal. The base station 110 may be also called “an access point (AP)”, “an eNodeB (eNB)”, “a 5th generation (5G) node”, “a gNodeB (next generation node B, gNB)”, “a wireless point”, “a transmission/reception point (TRP)” or other terms having a technical meaning equivalent thereto.

Each of the terminal 120 and the terminal 130 is a device used by a user and communicates with the base station 110 through a wireless channel. A link oriented from the base station 110 to the terminal 120 or the terminal 130 may be referred to as a downlink (DL), and a link oriented from the terminal 120 or the terminal 130 to the base station 110 may be referred to as an uplink (UL). In addition, although not illustrated in FIG. 1, according to an embodiment, the terminal 120 and the terminal 130 may perform communication with each other through a wireless channel. A link (device-to-device link, D2D) between the terminal 120 and the terminal 130 may be called a sidelink, and a sidelink may be used together with a PC5 interface. In some cases, at least one of the terminals 120 and 130 may be operated without involvement of a user. For example, at least one of the terminal 120 and the terminal 130 may be a device that performs machine-type communication (MTC) and may not be carried by a user. Each of the terminal 120 and the terminal 130 may also be called “a user equipment (UE)”, “a mobile station”, “a subscriber station”, “a remote terminal”, “a wireless terminal”, “a user device”, or other terms having a technical meaning equivalent thereto.

The base station 110, the terminal 120, and the terminal 130 may transmit and receive a wireless signal in a millimeter wave (mmWave) band (e.g., 28 GHz, 30 GHz, 38 GHz, and 60 GHz). To improve channel gain, the base station 110, the terminal 120, and the terminal 130 may perform beamforming. Beamforming may include transmission beamforming and reception beamforming. That is, the base station 110, the terminal 120, and the terminal 130 may give directivity to a transmission signal or a reception signal. To this end, the base station 110 and the terminals 120 and 130 may select serving beams 121 and 131 through a beam search or beam management procedure. After the serving beams 121 and 131 are selected, subsequent communication may be performed through resources having a quasi-co-located (QCL) relation with resources used for transmission of the serving beams 121 and 131.

If large-scale characteristics of a channel having transferred a symbol on a first antenna port are inferable from a channel having transferred a symbol on a second antenna port, the first antenna port and the second antenna port may be assessed as having a QCL relation therebetween. For example, the large-scale characteristics may include at least one of delay spread, Doppler spread, Doppler shift, average gain, average delay, and a spatial receiver parameter.

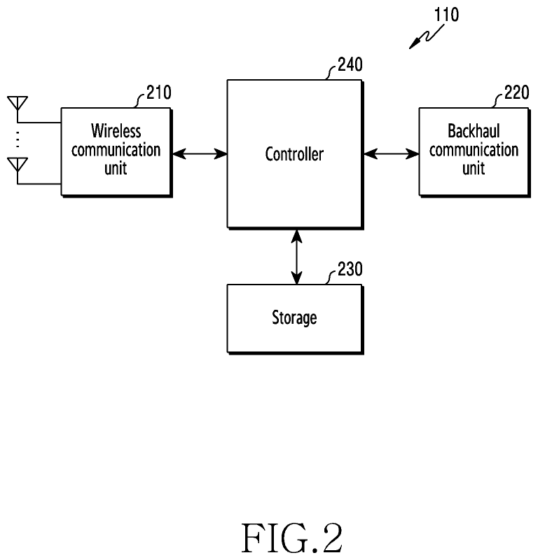

FIG. 2 is a block diagram illustrating an example configuration of a base station in a wireless communication system according to various embodiments. The structure illustrated in FIG. 2 may be understood as a structure of the base station 110. As used herein, the term “ . . . unit”, “ . . . er”, or the like refers to a unit configured to process at least one function or operation, and may be implemented as hardware, software, or a combination of hardware and software. Referring to FIG. 2, the base station includes a wireless communication unit (e.g., including communication circuitry) 210, a backhaul communication unit (e.g., including various circuitry) 220, a storage (e.g., a memory) 230, and a controller (e.g., including various circuitry) 240.

The wireless communication unit 210 may include various communication circuitry and performs functions for transmittingtreceiving signals through a radio channel. For example, the wireless communication unit 210 performs functions of conversion between baseband signals and bitstrings according to the physical layer specifications of the system. For example, during data transmission, the wireless communication unit 210 encodes and modulates a transmitted bitstring to generate complex symbols. In addition, during data reception, the wireless communication unit 210 demodulates and decodes a baseband signal to reconstruct a received bitstring.

Furthermore, the wireless communication unit 210 up-converts a baseband signal to an RF band signal, transmits the same through an antenna, and down-converts an RF band signal received through the antenna to a baseband signal. To this end, the wireless communication unit 210 may include a transmission filter, a reception filter, an amplifier, a mixer, an oscillator, a digital to analog converter (DAC), an analog to digital converter (ADC), and the like. In addition, the wireless communication unit 210 may include multiple transmission/reception paths. Furthermore, the wireless communication unit 210 may include at least one antenna array including multiple antenna elements.

In terms of hardware, the wireless communication unit 210 may include a digital unit and an analog unit, and the analog unit may include multiple sub-units according to operation power, frequencies, etc. The digital unit may be implemented by at least one processor (e.g., digital signal processor (DSP)).

The wireless communication unit 210 transmits and receives signals as described above. Accordingly, all or part of the wireless communication unit 210 may be referred to as a “transmitter”, a “receiver”, or a “transceiver”. In addition, as used in the following description, the meaning of “transmission and reception performed through a radio channel” includes the meaning that the above-described processing is performed by the wireless communication unit 210.

The backhaul communication unit 220 may include various circuitry and provides an interface for performing communication with other nodes in the network. That is, the backhaul communication unit 220 converts a bitstring, transmitted from the base station to any other node, for example, any other access node, any other base station, an upper node, or a core network, into a physical signal, and converts a physical signal, received from any other node, into a bitstring.

The storage 230 may include, for example, a memory and stores data such as basic programs, application programs, and configuration information for operations of the base station. The storage 230 may include a volatile memory, a nonvolatile memory, or a combination of a volatile memory and a nonvolatile memory. In addition, the storage unit 230 provides the stored data at the request of the controller 240.

The controller 240 may include various circuitry and controls the overall operation of the base station. For example, the controller 240 transmits/receives signals through the wireless communication unit % n or the backhaul communication unit 220. In addition, the controller 240 records data in the storage 230 and reads the data from the storage 230. Furthermore, the controller 240 may perform functions of protocol stacks required by communication specifications. According to an embodiment, the protocol stacks may be included in the wireless communication unit 210. To this end, the controller 240 may include at least one processor including processing circuitry. The at least one processor may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. According to various embodiments of the disclosure, the controller 240 may control the base station to perform operations according to various embodiments described below.

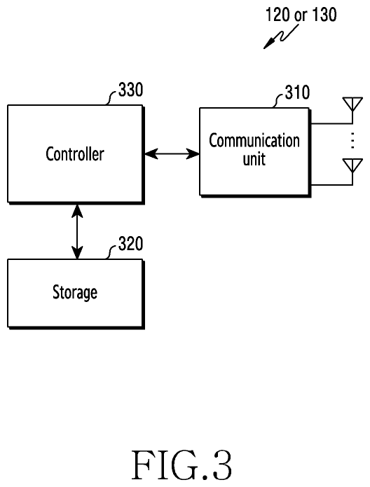

FIG. 3 is a block diagram illustrating an example configuration of a UE in a wireless communication system according to various embodiments. The structure illustrated in FIG. 3 may be understood as a structure of the UE 120 or 130. As used herein, the term “ . . . unit”, “ . . . er”, or the like refers to a unit configured to process at least one function or operation, and may be implemented as hardware, software, or a combination of hardware and software. Referring to FIG. 3, the UE may include a communication unit (e.g., including communication circuitry) 310, a storage (e.g., including a memory) 320, and a controller (e.g., including various circuitry) 330.

The communication unit 310 may include various communication circuitry and performs functions for transmitting/receiving signals through a radio channel. For example, the communication unit 310 performs functions of conversion between baseband signals and bitstrings according to the physical layer specifications of the system. For example, during data transmission, the communication unit 310 encodes and modulates a transmitted bitstring to generate complex symbols. In addition, during data reception, the communication unit 310 demodulates and decodes a baseband signal to restore a received bitstring. In addition, the communication unit 310 up-converts a baseband signal to an RF band signal, transmits the same through an antenna, and down-converts an RF band signal received through the antenna to a baseband signal. For example, the communication unit 310 may include a transmission filter, a reception filter, an amplifier, a mixer, an oscillator, a DAC, an ADC, and the like.

In addition, the communication unit 310 may include multiple transmission/reception paths. Moreover, the communication unit 310 may include at least one antenna array including multiple antenna elements. In terms of hardware, the communication unit 310 may include a digital circuit and an analog circuit (e.g., a radio frequency integrated circuit (RFIC)). The digital circuit and analog circuit may be implemented as a single package. In addition, the communication unit 310 may include multiple RF chains. Furthermore, the communication unit 310 may perform beamforming.

The communication unit 310 transmits and receives signals as described above. Accordingly, all or part of the communication unit 310 may be referred to as a “transmitter”, a “receiver”, or a “transceiver”. In addition, as used in the following description, the meaning of “transmission and reception performed through a radio channel” includes the meaning that the above-described processing is performed by the communication unit 310.

The storage 320 may include a memory and stores data such as basic programs, application programs, and configuration information for operations of the UE. The storage 320 may include a volatile memory, a nonvolatile memory, or a combination of a volatile memory and a nonvolatile memory. In addition, the storage 320 provides the stored data at the request of the controller 330.

The controller 330 may include various circuitry and controls the overall operation of the UE. For example, the controller 330 transmits/receives signals through the communication unit 310. In addition, the controller 330 records data in the storage 320 and reads the data from the storage unit 320. In addition, the controller 330 may perform functions of protocol stacks required by communication specifications. To this end, the controller 330 may include at least one processor, comprising processing circuitry, or microprocessor, or may be a part of a processor. The at least one processor or microprocessor may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. In addition, a part of the communication unit 310 and the controller 330 may be referred to as a communication processor (CP). According to various embodiments, the controller 330 may control the UE to perform operations according to various embodiments described below.

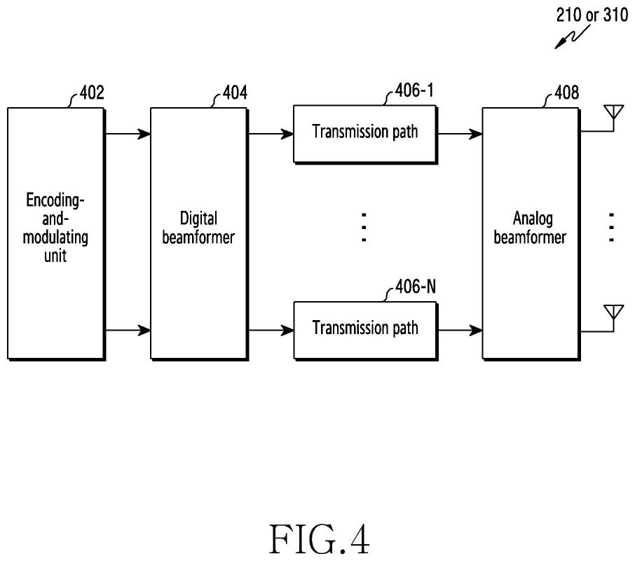

FIG. 4 is a block diagram illustrating an example configuration of a communication unit in a wireless communication system according to various embodiments. FIG. 4 illustrates an example of a specific configuration of the wireless communication unit 210 illustrated in FIG. 2 or the communication unit 310 illustrated in FIG. 3. For example, FIG. 4 shows an example of elements for performing beamforming, which are a part of the wireless communication unit 210 in FIG. 2 or the communication unit 310 in FIG. 3.

Referring to FIG. 4, the wireless communication unit 210 or the communication unit 310 includes an encoding-and-modulating unit (e.g., including circuitry) 402, a digital beamformer (e.g., including circuitry) 404, a plurality of transmission paths 406-1 to 406-N, and an analog beamformer (e.g., including circuitry) 408.

The encoding-and-modulating unit 402 may include various circuitry and performs channel encoding. For channel encoding, at least one of a low density parity check (LDPC) code, a convolution code, and a polar code may be used. The encoding-and-modulating unit 402 generates modulation symbols by performing constellation mapping.

The digital beamformer 404 may include various circuitry and performs beamforming for a digital signal (e.g., modulation symbols). To this end, the digital beamformer 404 multiplies modulation symbols by beamforming weights. Beamforming weights are used for changing the size and the phase of a signal, and may be called “a precoding matrix”, “a precoder”, etc. The digital beamformer 404 outputs digital-beamformed modulation symbols to the plurality of transmission paths 406-1 to 406-N. According to a multiple input multiple output (MIMO) transmission technique, the modulation symbols may be multiplexed, or the same modulation symbol may be provided to the plurality of transmission paths 406-1 to 406-N.

The plurality of transmission paths 406-1 to 406-N convert digital-beamformed digital signals into analog signals. To this end, each of the plurality of transmission paths 406-1 to 406-N may include an inverse fast Fourier transform (IFFY) calculator, a cyclic prefix (CP) insertion unit, a DAC, and an up converter. The CP insertion unit is designed for an orthogonal frequency division multiplexing (OFDM) scheme, and may be excluded when other physical layer schemes (e.g., filter bank multi-carrier (FBMC)) are applied. That is, the plurality of transmission paths 406-1 to 406-N provide independent signal processing processes for multiple streams generated through digital beamforming. However, according to an implementation method, some of the elements of the plurality of transmission paths 406-1 to 406-N may be shared.

The analog beamformer 408 may include various circuitry and perform beamforming for an analog signal. To this end, the digital beamformer 404 may multiply analog signals by beamforming weights. Beamforming weights are used for changing the size and the phase of a signal. For example, according to a connection structure between the plurality of transmission paths 406-1 to 406-N and antennas, the analog beamformer 440 may be variously configured. For example, each of the plurality of transmission paths 406-1 to 406-N may be connected to one antenna array. As another example, the plurality of transmission paths 406-1 to 406-N may be connected to one antenna array. As yet other example, the plurality of transmission paths 406-1 to 406-N may be adaptively connected to one antenna array or two or more antenna arrays.

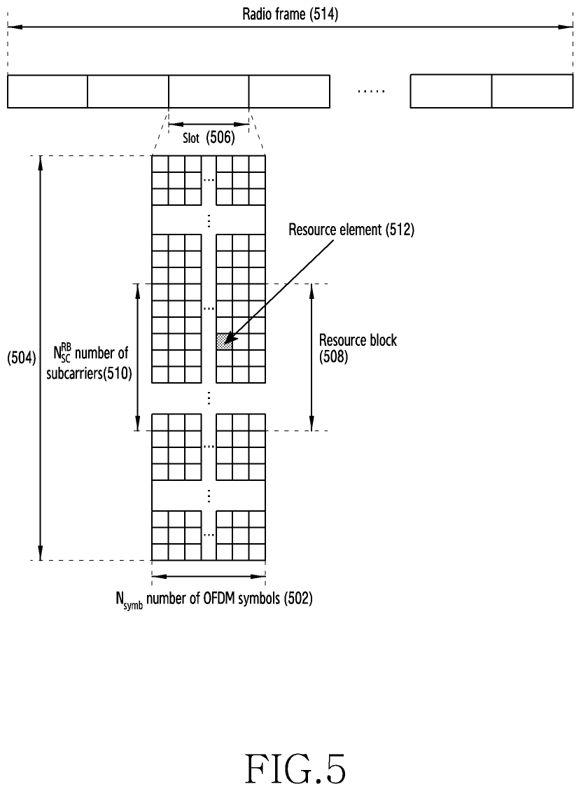

FIG. 5 is a diagram illustrating an example resource structure of a time-frequency domain in a wireless communication system according to various embodiments. FIG. 5 shows an example of a basic structure of a time-frequency domain which is a wireless resource area in which data or a control channel is transmitted in a downlink or uplink. Hereinafter, in the disclosure, orthogonal frequency division multiplexing (OFDM) defined by time-frequency resources is illustrated as a resource structure, but resource structure types of various schemes, such as TDM, FDM, CDM, or SC-FDMA, capable of segmentation based on time and frequency may be defined.

In FIG. 5, the transverse axis indicates a time domain, and the longitudinal axis indicates a frequency domain. A minimum transmission unit in the time domain is an OFDM symbol, and Nsymb number of OFDM symbols 502 comprise one slot 506. For example, in LTE or NR systems, the length of a subframe may be defined as 1.0 ms, and the length of a radio frame 514 may be defined as 10 ms. A minimum transmission unit in the frequency domain is a subcarrier, and a carrier bandwidth configuring a resource grid is configured by NBW number of subcarriers 504.

A basic unit of resources in the time-frequency domain is a resource element (hereinafter, “RE”) 512, and may be represented by an OFDM symbol index and a subcarrier index. A resource block may include multiple resource elements. In LTE systems, a resource block (RB) (or physical resource block, hereinafter, referred to as “PRB”) is defined as Nsymb number of consecutive OFDM symbols in the time domain and NSCRB number of consecutive subcarriers in the frequency domain. In NR systems, a resource block (RB) 508 may be defined as NSCRB number of consecutive subcarriers 510 in the frequency domain. The one RB 508 includes NSCRB number of REs 512 on the frequency axis. In general, a minimum transmission unit of data is an RB, and NSCRB indicating the number of subcarriers is 12. The frequency domain may include common resource blocks (CRBs). A physical resource block (PRB) may be defined in a bandwidth part (BWP) in the frequency domain. CRB and PRB numbers may be determined according to a subcarrier spacing. A data transmission rate (data rate) may increase in proportion to the number of RBs scheduled to a terminal.

A terminal may continuously move in a wireless environment. In order to provide a robust communication environment to such terminals, a base station performing scheduling is required to predict a more correct channel state. In a current 3GPP specification, scheduling is performed, based on an SRS transmitted by a terminal (e.g., satisfaction of channel reciprocity in time division duplex (TDD)) or based on CSI reported by a terminal (e.g., frequency division duplex (FDD) satisfaction). However, such an SRS or CSI is not updated at every transmission time interval (TTI) that is a scheduling unit and thus may not be accurate. Moreover, continuously transmitting an SRS or frequently reporting CSI imposes a burden on a terminal. Therefore, a method is required for a base station to predict or estimate the current channel state more accurately, from periodically or intermittently obtained channel information, until next channel information is acquired. In particular, multiple input multiple output (massive MIMO), where multiple antennas are utilized to increase channel gain, is being considered, and the higher the accuracy of channel information, the higher the massive MIMO gain may be obtained. Therefore, even for moving terminals, it is necessary to predict channel information on a time-varying channel, rather than relying solely on periodic CSI feedback information, to perform scheduling and beamforming, based on more accurate channel information.

For example, in relation to channel prediction, a channel prediction technique may be used also in a technique using SRS channel information in a TDD massive (multiple-input and multiple-output (MIMO) environment. However, such channel prediction techniques based on SRS channel information may involve high complexity in directly predicting channel information or extracting a channel parameter. Therefore, due to the high complexity, the number of terminals available per slot may be limited to 1 or 2. In particular, in TDD channel prediction, correction of a time or frequency offset is required to be prioritized, based on an uplink channel estimation technique algorithm, and since the dimension (e.g., Nₜₓ×N_{rb}) of a channel matrix to be used for channel prediction is very large, it may be difficult to perform channel estimation at low complexity.

In the following disclosure, a technology usable for multi-user (MU)-MIMO using an enhanced Type II (eType II) codebook having high CSI accuracy is described. In particular, according to various embodiments of the disclosure, in consideration of fast-moving terminals, a prediction technique for a low-dimensional linear combination coefficient is possible by appropriately utilizing a PMI parsing technique and a joint space-frequency basis expansion model included in an eType II codebook. As a result, an adaptive Kalman filter-based channel prediction technique with low complexity is described. However, channel estimation according to various embodiments of the disclosure is not limited to the above example. In addition to a base station, another network entity or a separate computational device equipped in the base station may perform channel estimation according to various embodiments described later, or in distributed deployment or distributed MIMO, a CU or equipment connected to the CU may also perform channel estimation. Although an example of estimating a downlink channel from a base station to a terminal is described, it is understood that channel estimation of the disclosure is appliable even to estimation of an uplink channel from a terminal to a base station and estimation of a sidelink channel between terminals.

A channel estimation device according to various embodiments of the disclosure predicts channel parameters, based on previous channel information obtained from a PMI. A base station may determine a current channel state, based on a previous channel state and a currently obtained measurement information. Determining a channel state may be replaced with obtaining or acquiring, calculating, identifying, predicting, or estimating a channel state, or a term having a meaning equivalent thereto.

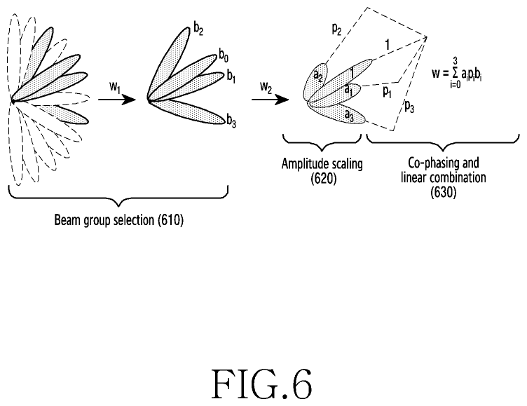

FIG. 6 is a diagram illustrating an example of generating channel information based on a linear combination codebook according to various embodiments. For example, FIG. 6 illustrates an example of a codebook based on Type II of NR.

As described above, a codebook may indicate a set of precoders (e.g., a set of precoding matrixes) in view of CSI-RSs. That is, a codebook may denote a type of matrix having a complex value, for converting a data bit into a set of different pieces of data mapped to antenna ports.

A codebook defined in 5G NR may include two types of codebooks. According to an embodiment, a Type I codebook may be defined using a previously defined collection of matrixes. Unlike this, a Type II codebook may be defined based on a formula defined to include many parameters as well as a pre-defined table. Accordingly, a more refined precoding matrix compared to a Type I codebook may be applied according to a Type II codebook.

Specifically, according to an embodiment, while CSI feedback of Type I defines only the phase of a selected beam rather than the amplitude thereof, CSI feedback of Type II may include amplitude information of a wideband and a subband of a selected beam. That is, there is a difference in that a codebook of Type I selects only a single particular beam from a beam group, whereas a codebook of Type II selects a beam group and linearly combines all beams in the group.

With reference to FIG. 6 illustrating an example of a Type II codebook, according to an embodiment, a wideband beam group may be selected based on a W₁ vector for channel information compression (CSI compression) based on a spatial beam (spatial-domain beam) (610). Thereafter, the amplitudes of beam groups may be scaled based on the selected wideband beam group and a W₂ vector (620) and the phases thereof may be adjusted through a co-phasing parameter and a linear combination process (630).

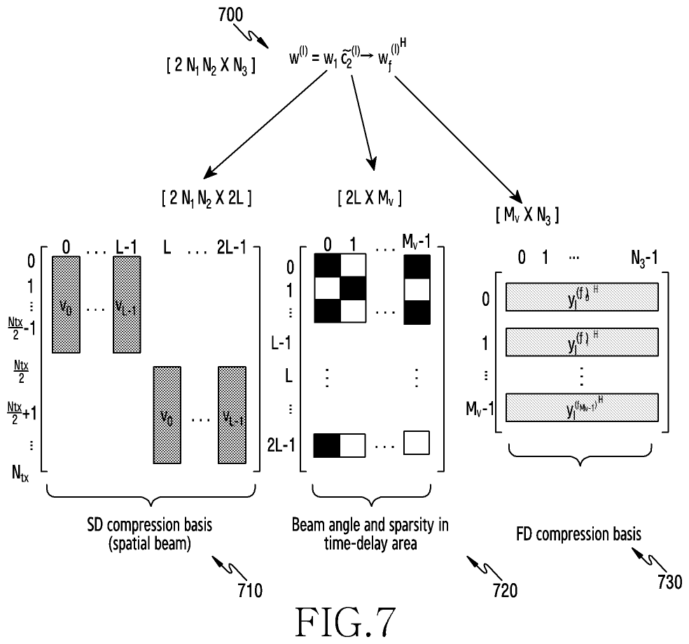

According to various embodiments of the disclosure, after introduction of a Type II codebook, an enhanced Type II (eType II) codebook for more enhanced channel estimation has been introduced and hereinafter, will be described in greater detail with reference to FIG. 7.

FIG. 7 is a diagram illustrating an example of a codebook matrix based on a spatial domain and a frequency domain according to various embodiments. For example, referring to FIG. 7, a channel matrix based on an eType II codebook technique will be described in greater detail.

According to an embodiment, a base station may parse CSI received from a UE, and obtain codebook information configuring at least some elements of a precoding matrix, based the parsed CSI. The base station may classify pieces of parsed information of precoding matrix information (e.g., a precoding matrix indicator (PMI)) of the UE. The base station may calculate a precoding matrix (e.g., a PMI) so as to enable detection of whether a spatial domain (SD)/frequency domain (FD) basis set used in a previous or next state of a moving UE is changed, from a change of relevant index information. Specifically, the base station may identify an indirect change degree of a corresponding channel from index information related to a promised spatial domain (SD)/frequency domain (FD) basis set, and a change of the accumulated pieces of index information. Various embodiments of the disclosure based on these properties may be differentiated from a method of configuring a full-size channel matrix using a PMI and then extracting a channel parameter, as in TDD massive MIMO, from the temporal change in the full-size channel matrix. As described above, according to various embodiments of the disclosure, a technique similar to channel prediction techniques based on SRS channel information is applied to PMI channel information, thereby enabling overcoming of problems wherein high complexity is incurred by performing of a calculation of directly predicting decompressed (e.g., reconstructed) channel information or extracting a channel parameter again, and the number of UEs available per slot is limited to a small number.

In addition, according to various embodiments of the disclosure, in a case of a moving UE, with respect to a time-varying channel established between the base station and the UE, a base station may parse a periodic PMI of a UE, and predict the time-varying channel, based on a rotation matrix obtained by pre-calculating a correlation between an SD basis and an FD basis at the time of conversion of an index related to a parsed SD/FD base. In addition, a rotation matrix generated for a UE moving at a high speed may be prepared in a form of a lookup table (LUT) and applied for a design of low complexity. This method, rather than performing direct and complex channel prediction, based on a large-dimensional channel matrix generated after a full-size channel matrix is reconstructed from precoding matrix information (PMI), may simply detect only a change of a PMI index (i₁, i₂, etc.) of a UE for a time-varying channel to use values in a directly mapped table. If a change of an index related to a parsed SD/FD base, which has been periodically reported by a UE for a time-varying channel, is detected, a base station may simply use a pre-calculated rotation matrix to predict the time-varying channel so as to lower complexity in predicting the time-varying channel. In addition, in various embodiments of the disclosure, prediction of an accurate channel coefficient value for a moving UE or prediction of a Doppler parameter is possible at a low complexity so as to enable a Kalman filter technique to be stability applied to linear combination coefficients having a low dimension (e.g., reduced dimensionality or low dimensionality) mapped to a parsed SD/FD base.

According to an embodiment, referring to FIG. 7, a precoding channel matrix (e.g., a matrix having (the number of transmission antennas X the number of subbands) dimensions) corresponding to an enhanced type II codebook of 3GPP release 16 may be calculated from a matrix product of W₁, W′₂, and W_{f}^{H} extracted from a PMI (i1, i2).

$$W = {W}_{1} {W}_{2}^{′} {W}_{f}^{H} \qquad [ Equation 1 ]$$

The matrix Wᵢ is an element expressing a spatial domain (SD) for a channel established between a base station and a UE, configures a channel, may represent an SD beam component of the PMI using a set of 2D DFT column vectors expressing a vertical/horizontal channel component in the SD area, and may be used for compression of the SD area. For example, the matrix Wᵢ may include, in a form of a tall matrix, a matrix relating to an SD compression basis in relation to a spatial beam (710). W_{f}^{H} is a frequency domain (FD) element for a channel established between the base station and the UE and may represent a DFT basis component in the frequency domain of the PMI. For example, W_{f}^{H} may include a matrix relating to an FD compression basis (730). W₂′ is a matrix having a channel sparsity characteristic for a joint SD/FD component of a channel, and each element of W₂′ may indicate a channel coefficient value mapped to a row vector and an SD basis (e.g., a DFT column vector in the SD area) of Wᵢ mapped to a row value of the element of W′₂, and each FD basis (e.g., a DFT row vector in the FD area) mapped to a column value. According to an embodiment, W₂′ may indicate C₂^{(l)} in FIG. 7 (hereinafter, these parameter may be used together for convenience), and may include a matrix relating to a beam angle and time-delay sparsity (720).

Each of {W₁, W_{f}^{H}, W′₂} may be calculated after relevant index information is parsed or extracted from PMI reporting (e.g., the indexes i1 and i2) of the UE, and a result value of the downlink channel matrix information W^{(l)} 700, which is a final result value, may be calculated as a final result of a downlink precoding matrix weight which is acquirable by the base station on each layer.

A precoding vector for an 1-th layer for a PMI received from the UE may be represented as Equation 2 below.

$${W}_{l} = [ {W}_{l}^{( 0 )} … {W}_{l}^{( {N}_{3} - 1 )} ] = {W}_{1 ,} {W}_{2 , l}^{′} {W}_{f , l}^{H} \qquad [ Equation 2 ]$$

N₃ may be the number of subbands or may also be the number of FD units, and the size of a precoding matrix corresponding to the 1-th layer may be 2N₁N₂×N₃. As shown in Table 1 below, the base station may extract channel matrix information for each layer, in the same method as described for Equation 1, from partial information of PMI reporting (e.g., the indexes iₜ and i₂) received from the UE.

According to an embodiment, if a rank of a precoder reported from the UE is u and the number of FD subband units is n, a precoding matrix may include u layers corresponding to 2N₁ N₂ number of antenna ports as shown in Equation 3 below.

$${W}^{( n )} = [ {W}_{0}^{( n )} … {W}_{υ - 1}^{( n )} ] \qquad [ Equation 3 ]$$

According to an embodiment, Wᵢ in Equation 3 may represent an SD beam set of 2D DFT beams, and may be expressed as Equation 4 below.

$${W}_{1} = [ \begin{matrix}B & 0 \\ 0 & B\end{matrix} ] = [ \begin{matrix}{υ}_{1} {υ}_{2} … {υ}_{L} & 0 \\ 0 & {υ}_{1} {υ}_{2} … {υ}_{L}\end{matrix} ] \qquad [ Equation 4 ]$$

Block diagonal matrix B may be represented by a set of L number of selected SD beams (e.g., a set of DFT column vectors in the SD area) [ν1 ν2 . . . νL]. Wᵢ may be expressed by the same set of I number of SD beams for all frequency domain (FD) subbands and all layers. DFT column vectors in the SD area may be a known weighted vector previously promised between the base station and the UE, and may also be used as a basis of CSI channel information compression in the SD area. For example, information corresponding to rotation factors of beams of q₁ and q₂ may be extracted from i_{1,1} that is partial information of PMI (i₁), and n₁ᵢ and n₂ᵢ (orthogonal beam indices) information may be extracted from i_{1,2} that is partial information of PMI (ii).

TABLE 1

| Number of CSI-RS antenna | | |
|---|---|---|
| ports, PCSI-RS | (N₁, N₂) | (O1, O2) |
| 4 | (2, 1) | (4, 1) |
| 8 | (2, 2) | (4, 4) |
| | (4, 1) | (4, 1) |
| 12 | (3, 2) | (4, 4) |
| | (6, 1) | (4, 1) |
| 16 | (4, 2) | (4, 4) |
| | (8, 1) | (4, 1) |
| 24 | (4, 3) | (4, 4) |
| | (6, 2) | (4, 4) |
| | (12, 1) | (4, 1) |
| 32 | (4, 4) | (4, 4) |
| | (8, 2) | (4, 4) |
| | (16, 1) | (4, 1) |

{m1(i), m2(i)} finally denoted as SD basis indexes of an i-th beam may be expressed as shown in the following equation by combining information (q₁, q₂) corresponding to rotation factors of beams of q₁ and q₂ from the above information i_{1,1}, and n₁ᵢ and n₂ᵢ (orthogonal beam indices) information from the information i_{1,2} with oversampling factors {O1, O2} configured in a horizontal/vertical dimension according to the shape of a radio unit (RU) according to Table 1.

$${u}_{{m}_{1}^{( i )}} = [ 1 , {e}^{j \frac{2 π {m}_{1}^{i}}{{O}_{2} {N}_{2}}} , … , {e}^{j \frac{2 π {m}_{1}^{i} ( {N}_{2} - 1 )}{{O}_{2} {N}_{2}}} ] \qquad [ Equation 5 ]$$

m1(i): beam index in vertical domains for i-th beam, here
m1(i)=O1,·n₁ᵢ+q₁

$${υ}_{{m}_{2}^{( i )}} = [ 1 , {e}^{j \frac{2 π {m}_{2}^{i}}{{O}_{1} {N}_{1}}} , … , {e}^{j \frac{2 π {m}_{2}^{i} ( {N}_{1} - 1 )}{{O}_{1} {N}_{1}}} ] \qquad [ Equation 6 ]$$

m2(i): beam index in vertical domains for i-th beam, here

m2(i)=O2,·n₂ᵢ+q₂

According to an embodiment, a codebook according to a combination of an SD beam and an FD beam may be calculated by performing linear combination for L number of spatial domain (SD) DFT vectors, that is, column vectors of W₁, and Mu number of frequency domain (FD) DFT vectors, that is column vectors of W_{f,l}=[yₗ^{(f=0)}, . . . yₗ^{(f=M}^{_{ν}}⁻¹⁾] which are an FD set of the 1-th layer.

According to an embodiment, when the FD beam set matrix W′_{2,l} is represented as in Equation 7 below, a precoding vector for the 1-th layer for the received PMI may be represented using a linear combination configured by linear coefficients of an SD beam set [ν1 ν2 . . . νL] and an FD beam set W_{f,l}=[yₗ^{(f=0)}, . . . ,yₗ^{(f=M}^{_{ν}}⁻¹⁾] as shown in Equation 8 below.

$${W}_{2 , ( l )}^{′} = [ \begin{matrix}{w}_{1 , 0 , 0} & … & {w}_{1 , 0 , {M}_{υ} - 1} \\ ⋮ & ⋱ & ⋮ \\ {w}_{l , 2 L - 1 , 0} & … & {w}_{l , 2 L - 1 , {M}_{υ} - 1}\end{matrix} ] \qquad [ Equation 7 ]$$

In other words, the elements of the linear combination (LC) coefficient matrix W′_{2,l} of Equation 7 are configured by 2L×Mν number of elements, and each element may include an LC coefficient expressed by an amplitude value and a phase value (720). Respective elements corresponding to an i-th row and an f-th column of the LC coefficient matrix W′_{2,l} may be are mapped to an i-th column vector (e.g., an i-th SD DFT column vector) of the W₁ matrix and an f-th row vector (e.g., an f-th SD DFT row vector) of the W_{f} matrix, so that a precoding matrix may be expressed using a linear combination configured by linear coefficients of an SD beam set [ν1 ν2 . . . νL] and an FD beam set W_{f,l}=[yₗ^{(f=0)}, . . . , yₗ^{(f=M}^{_{ν}}⁻¹⁾] as shown in Equation 8 below.

$${W}^{( l )} = \frac{1}{\sqrt{{N}_{1} {N}_{2} {γ}_{l}}} [ \begin{matrix}{\sum }_{i = 0}^{L - 1} {\sum }_{f = 0}^{{M}_{υ} - 1} {w}_{l , i , f} {υ}_{{m}_{1}^{( i )} , {m}_{2}^{( i )}} {y}_{l}^{{( f )}^{H}} \\ {\sum }_{i = 0}^{L - 1} {\sum }_{f = 0}^{{M}_{υ} - 1} {w}_{l , i + L , f} {υ}_{{m}_{1}^{( i )} , {m}_{2}^{( i )}} {y}_{l}^{{( f )}^{H}}\end{matrix} ] \qquad [ Equation 8 ]$$

According to an embodiment, referring to a precoding weight matrix structure of Equation 8 described above, W^{(l)} of Equation 9 may be expressed as below from a precoding matrix formula for a moving UE.

$$\begin{matrix}{W}^{( l )} = \frac{1}{\sqrt{{N}_{1} {N}_{2} {γ}_{l}}} [ \begin{matrix}{\sum }_{i = 0}^{L - 1} {v}_{{m}_{1}^{( i )} , {m}_{2}^{( i )}} {p}_{l , 0}^{( 1 )} {\sum }_{f = 0}^{{M}_{υ} - 1} {y}_{l}^{{( f )}^{H}} {p}_{l , i , f}^{( 2 )} {φ}_{l , i , f} \\ {\sum }_{i = 0}^{L - 1} {v}_{{m}_{1}^{( i )} , {m}_{2}^{( i )}} {p}_{l , 1}^{( 1 )} {\sum }_{f = 0}^{{M}_{υ} - 1} {y}_{l}^{{( f )}^{H}} {p}_{l , i + L , f}^{( 2 )} {φ}_{l , i + L , f}\end{matrix} ] \\ = \frac{1}{\sqrt{{N}_{1} {N}_{2} {γ}_{l}}} [ \begin{matrix}{\sum }_{i = 0}^{L - 1} {\sum }_{f = 0}^{{M}_{υ} - 1} {p}_{l , 0}^{( 1 )} {p}_{l , i , f}^{( 2 )} {φ}_{l , i , f} {v}_{{m}_{1}^{( i )} , {m}_{2}^{( i )}} {y}_{l}^{{( f )}^{H}} \\ {\sum }_{i = 0}^{L - 1} {\sum }_{f = 0}^{{M}_{υ} - 1} {p}_{l , 1}^{( 1 )} {p}_{l , i + L , f}^{( 2 )} {φ}_{l , i + L , f} {v}_{{m}_{1}^{( i )} , {m}_{2}^{( i )}} {y}_{l}^{{( f )}^{H}}\end{matrix} ] \\ = \frac{1}{\sqrt{{N}_{1} {N}_{2} {γ}_{l}}} [ \begin{matrix}{\sum }_{i = 0}^{L - 1} {\sum }_{f = 0}^{{M}_{υ} - 1} {c}_{l , i , f} {v}_{{m}_{1}^{( i )} , {m}_{2}^{( i )}} {y}_{l}^{{( f )}^{H}} \\ {\sum }_{i = 0}^{L - 1} {\sum }_{f = 0}^{{M}_{υ} - 1} {c}_{l , i + L , f} {v}_{{m}_{1}^{( i )} , {m}_{2}^{( i )}} {y}_{l}^{{( f )}^{H}}\end{matrix} ]\end{matrix} \qquad [ Equation 9 ]$$

According to an embodiment, the base station may obtain a differential amplitude combination index from a CSI report according to movement of a UE, and the differential amplitude combination index p_{l,i,f}_{₁}⁽²⁾=0, p_{l,i,f}_{₂}⁽²⁾=0, for i=j=0, . . . ,2L−1 may be obtained based on elements having a large amplitude difference by performing an inverse transform calculation and a modular calculation for FD beam matrixes of two UEs using the sparsity characteristics of PMIs of the two UEs. For example, the base station may find the position of the strongest layer in a column vector for each layer of an FD beam set matrix to obtain a strongest coefficient index.

According to an embodiment, an SD beam difference index, a phase difference index, or a differential amplitude combination index between CSI may be separately calculated from PMIs extracted from pieces of CSI of a moving UE, and a correlation may be updated by combining the values thereof.

According to an embodiment, a correlation may be used to calculate a rotation matrix for an SD/FD component of CSI reported at different times using a change of an SD component index and a change of an FD component index between CSI, based on PMIs extracted from CSI reports of a moving UE for a time-varying channel, or a rotation matrix mapped to SD/FD index information may be calculated using a form of a pre-calculated table value, and additionally, channel prediction information may be updated at low complexity based on a combination of these values.

According to an embodiment, a correlation and a rotation matrix may be calculated based on a combination of a difference value of Wᵢ (e.g., an SD beam difference value) and a difference value of W_{f}^{H} (e.g., an FD beam difference value) between CSI, the difference values being calculated using a precoding matrix of each CSI transmitted by a moving UE.

According to an embodiment, in view of indexes of an SD/FD basis set of compressed CSI feedback periodically updated by a UE for a time-varying channel, in a case of a moving UE, a set of some indexes is partially maintained and only a set of the remaining indexes is changed in many cases. Therefore, a base station may detect a change of an SD/FD index of compressed channel feedback to classify an SD/FD basis component of an eType 2 PMI report having a time difference for a period interval into a changed set and a non-changed set, and apply a rotation matrix only to a variance corresponding to the changed set so as to minimize/reduce complexity required for channel prediction. When an SD/FD basis component is changed and thus classified into a changed set, linear combination (LC) coefficients may be used to predict or track a channel in consideration of all components in the changed set for a previous time and a current time.

According to an embodiment, in a case of a stationary UE or a low-speed UE, there are many cases where all indexes of a SD/FD basis set are maintained without being changed. In this case, a rotation matrix is reflected as an identity matrix, and thus only prediction for a linear combination (LC) coefficient using a Kalman filter is used without separately calculating a rotation matrix so that entire channel information prediction may be performed at low complexity. The faster the moving speed of a UE, the more frequently an index of an SD/FD basis set is changed, and a cardinality number of a changed set may be increased. In this case, only a rotation matrix component corresponding to the changed set is updated and a rotation matrix component corresponding to a non-changed set maintains an existing value whereby complexity required in channel prediction may be reduced, and similarly to the above operations, a pre-calculated rotation matrix may also be used in a form of a lookup table (LUT).

According to an embodiment, a rotation matrix and a correlation described above may be easily calculated at the time of channel prediction, based on a nonzero coefficient weighted linear combination using, as bases, some column vectors of an amplitude factor of Wᵢ that is an SD component of a PMI and some row vectors of a phase factor of W_{f,(l)}^{H} that is an FD component of the PMI using Equations 8 and 9 and considering the channel sparsity of compressed channel feedback reported in a form of a PMI.

According to an embodiment, referring to Equation 3, in view of a linear combination configured by an SD basis of Wᵢ and an FD basis of W_{f,(l)}^{H} based on a characteristic of W′_{2,(l)} showing channel sparsity, linear combination using only non-zero coefficients may be performed. For example, components of 50% or higher of W′_{2,(l)} may be 0, and most energy may be concentrated on a DC component of W′_{2,(l)}, for example, the first column vector of W′_{2,(l)}. For example, in W′_{2,(l)} of an eType 2 PMI, there may be a total of 2LMν number of coefficients on each layer, and even if the values thereof including even the zero value are reported by PMI bits, only non-zero elements (coefficients) among W′_{2,(l)} components are considered to perform Kalman filter-based linear prediction at the time of channel prediction so that channel information may be reconfigured or as a result, channel information prediction may be performed. According to an embodiment, the following equation may be used in relation to sparsity.

### <Sparsity>

$$vec ( ABD ) = ( {D}^{T} ⊙ A ) vec ( B )$$

As described above, if a CSI compression structure of a Release 16 enhanced type II codebook is used, considering that CSI received from a UE is configured by 1) an SD basis, 2) an FD basis, and 3) a nonzero coefficient having a one-to-one mapping relation with the SD/FD basis, there may be an embodiment of, when a channel correlation value is obtained based on CSI information according to a reporting time, 1) calculating a rotation matrix mapped to an SD basis, based on an index change of L number of SD bases (N₁N₂-sized DFT vectors) between different pieces of CSI reported at different times, 2) calculating a rotation matrix mapped to an SD basis, based on an index change of M number of FD bases (N₃-sized DFT vectors) between different pieces of CSI reported at different times, and 3) calculating a linear prediction value mapped to a change of a nonzero coefficient having a one-to-one mapping relation with an SD/FD basis between CSI, so as to use the calculated matrixes and value for channel prediction.

More specifically, according to various embodiments of the disclosure, 1) L number of SD bases (N₁N₂-sized DFT vectors) and 2) M number of FD bases (N₃-sized DFT vectors) are known weighted vectors and thus a correlation value between bases may be calculated in advance, and PMI parsing values (i₁₁, i₁₂, i₁₆) between a previous CSI report and a next CSI report are compared using a PMI parsing technique so that whether there is a change of an SD/FD basis set used in a previous/next state of a moving UE may be detected from an index change. In addition, there may be an embodiment in which a channel estimation device generates, at the time of SD/FD basis conversion, a rotation matrix obtained by pre-calculating a correlation between an SD basis and an FD basis and stores the generated rotation matrix in a form of LUT.

In addition, according to an embodiment, based on the generated rotation matrix, filtered nonzero linear combination (LC) coefficients expressed on an SD/FD basis axis of a previous state having a reduced dimension may be expressed by filtered nonzero LC coefficients (e.g., filtered LC weight values) of the previous state expressed on the SD/FD basis axis of a current state. Accordingly, the filtered values of the previous state may be expressed based on the same SD/FD basis axis also in a next state. In addition, based on the values expressed on the same axis, reported nonzero LC coefficient values extracted through PMI parsing of CSI reported in the current state may have a lower dimension compared to an initial (original) channel having a full dimension (full dimensionality), and thus linear prediction or channel component (parameter) tracking based on a linear Kalman filter may be performed in association with the nonzero LC coefficient values. In addition, reconstruction of channel information may enable efficient channel prediction or channel tracking.

According to various embodiments of the disclosure, without being limited to the above example, a Doppler parameter, which is a non-linear component mapped to an SD/FD basis, may be extracted using a non-linear Kalman filter based on an extended Kalman filter (EKF) or unscented Kalman filter (UKF) other than a linear Kalman filter, and resultant correct CSI prediction may be performed. Therefore, rather than performing high-complexity unnecessary calculation requiring re-extraction of SD/FD bases after a compressed channel is reconstructed again, CSI reconstruction (e.g., CSI decompression) may be performed using SD/FD bases and LC coefficient values reported at different times, so that channel prediction at low complexity may be easily performed.

For example, compared to a channel prediction method having a 2N₁N₂×N₃ size of full dimension, according to the above embodiments, nonzero coefficients between W′_{2,(l)} of reported pieces of CSI may be calculated in a low (reduced) dimension, DFT vectors mapped to the spatial/frequency domain may also be known weights, and a DFT matrix mapped to the spatial/frequency domain has a property of a unitary matrix and thus a characteristic thereof may be easily used. For example, an inverse matrix of a DFT matrix is obtained by applying a Hermitian calculation to the DFT matrix, and thus may lower calculation complexity required in channel estimation.

According to an embodiment, a correlation may be calculated by linear combination between nonzero coefficients matched between an FD beam set and an SD beam set between CSI.

According to various embodiment of the disclosure, a correlation may be calculated by obtaining channel state information related to pieces of CSI received from a moving UE, and a difference value of some of spatial domain (SD) components and a difference value of some of frequency domain (FD) components of a preceding matrix based on the channel state information, respectively. In addition, according to an embodiment, a correlation may be calculated by linear combination for a difference value of an SD component and a difference value of an FD component.

In various embodiments of the disclosure, an SD beam set index of previous state CSI received from a moving UE may be calculated to be L number of elements each smaller than an SD component size, based on an orthogonal component and a rotation component (factor) of the SD beam set, and an SD beam set index of current state CSI may be calculated to be L number of elements, based on an orthogonal component and a rotation component (factor) of the SD beam set. According to various embodiment, a rotation matrix of an SD component may contribute to SD beam set indexes of pieces of CSI reported at different times being calculated at low complexity by commonly applying a rotation component (factor) to L orthogonal components. In addition, when a rotation matrix of an SD component is calculated, L orthogonal components are first calculated for each CSI reported at different times, and a commonly applied rotation component (factor) is commonly applied, whereby a required size of a lookup table may be reduced.

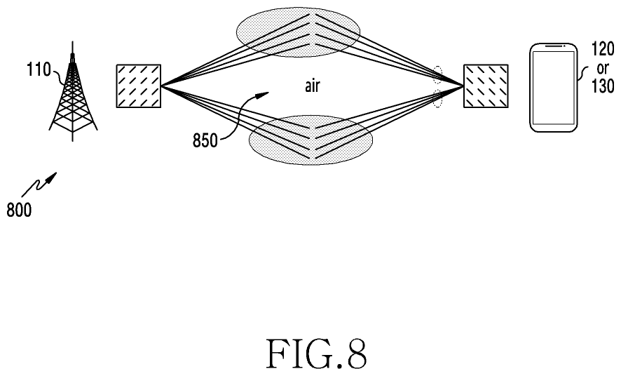

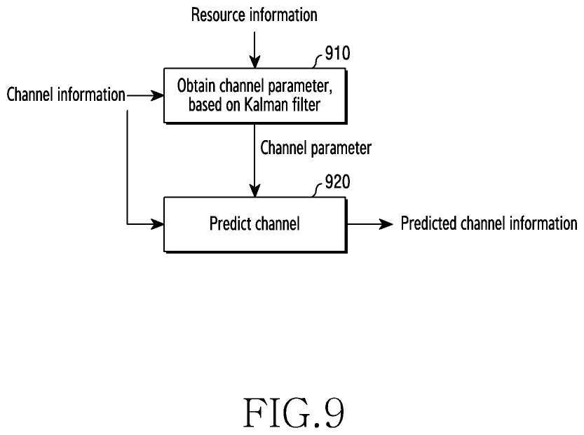

When a base station estimates a channel (e.g., calculates or predicts channel parameters), there is a need to also track parameters of a non-linear function. In this case, a base station according to various embodiments of the disclosure may also perform channel estimation based on an extended Kalman filter (EKF) method, which is a type of Kalman filter, or based on an unscented Kalmal filter (UKF) for performing low-complexity and efficient channel estimation. Hereinafter, with reference to FIG. 8 and FIG. 9, a system model and operation elements for extracting a non-linear component and performing channel estimation, based on a Kalman filter of the disclosure are described.

FIG. 8 is a diagram illustrating an example of a system model in a wireless communication system according to various embodiments. An example of a system model for downlink channel estimation between a base station and a UE is illustrated. An example of a base station is the base station 110 in FIG. 1, and an example of a UE is the terminal in FIG. 1. The resource structure of FIG. 5 is used as an example of a resource structure for description of a system model.

Referring to FIG. 8, a wireless environment 800 may include a wireless channel 850 between a base station and a UE. According to an embodiment, there may be a situation where the UE may report CSI for the wireless channel and the base station receives same and perform channel estimation. The wireless channel 850 may be dependent on a propagation path through which a signal is transferred and such a propagation path may be dependent on an antenna (q) of a transmission node. A signal radiated from one antenna may be provided to a reception node through one or more paths on air. In addition, in each path, the wireless channel 850 may be time-frequency dependent. Referring to FIG. 8, the base station and the UE may each have multiple transmission/reception antennas, multiple paths of a channel between the base station and the UE may be established, and here, a random path is denoted by p.

For example, the wireless channel 850 may be determined according to an antenna (q), a time (t), a frequency (f), and a Doppler parameter. The wireless channel may be expressed in a form of a tenser corresponding to a multi-dimensional array, a matrix, or a vector. A single-input single-output (SISO) channel established between a q-th antenna among multiple antennas of the base station and a UE having a single antenna may be expressed as a time-varying channel as shown in Equation 10 below. Downlink channel estimation in FDD is determined by a UE, based on a downlink CSI-RS, and uplink channel estimation in TDD may be determined by a base station, based on a downlink CSI-RS. In relation to the following system model, regardless of channel estimation for an FDD PMI and a TDD SRS channel estimation method, parameter prediction for a time-varying channel through a more general channel system model will be described as one of embodiments of channel information prediction. According to an embodiment, a wireless channel may be expressed by a vector, and may be expressed as in the following equation.

$${h}_{q} ( f , t ) = {\sum }_{p = 1}^{P} {γ}_{p , q} {e}^{- j 2 π ( f {τ}_{p} - {v}_{p} t )} \qquad [ Equation 10 ]$$

h_{q}(f, t) denotes a predicted channel estimation value for a time-frequency resource (t,f) in the q-th antenna. Tₚ denotes a delay parameter for path p, νₚ denotes a Doppler parameter for path p, and γ_{p,q} indicates a complex weight for antenna q on path p. In general, a Doppler parameter may have a characteristic of being proportional to the moving speed of a UE.

According to an embodiment, τₚ and νₚ are assumed to be identically applied regardless of antenna q, and γ_{p,q} may be assumed to be differently applied for each antenna.

According to an embodiment, a time-varying channel configured for antenna q and fin the frequency domain may be expressed as H(t), and may be expressed by a linear combination or linear sum of p number of nonzero coefficient for an SD/FD joint basis. Here, w_{f}(τₚ) may be assumed to be a frequency domain (e.g., frequency-domain basis vector) having a [N_{rb}×1] dimension mapped to a p-th joint (SD, FD) component, and wₐ(θₚ) may be a basis vector in the spatial domain (e.g., a spatial-domain basis vector) having a [Nₐₙₜ×1] dimension mapped to the p-th joint (SD, FD) component. In addition, a non-zero linear combination (LC) coefficient mapped to the p-th joint (SD, FD) component in a time-varying channel may be expressed by cₚ(t), and this may be associated with compressed channel feedback information of Equation 3 to Equation 9.

$$H ( t ) = {\sum }_{p} {w}_{f} ( {θ}_{p} ) \cdot {w}_{f}^{T} ( {τ}_{p} ) \cdot {c}_{p} ( t ) \qquad [ Equation 10 - 1 ]$$

According to an embodiment, referring to a relation between Equation 10 and Equation 10 1, the Doppler parameter νₚ for path p may be extracted, using a non-linear Kalman filter (e.g., EKF or UKG) algorithm, from change information of cₚ(t) mapped to compressed joint (SD, FD) in channel information of different times, based on a statistical characteristic of cₚ(t). In addition, according to an embodiment, channel information may be predicted using an SD/FD basis vector, predicted cₚ(t), or the extracted Doppler parameter νₚ based on the above equations.

According to an embodiment, an observed reception signal may be expressed as in the following equation.

$${y}_{q} ( {t}_{s} , {f}_{s} ) = {\hat{h}}_{q} ( {t}_{s} , {f}_{s} ) + {n}_{q} ( {t}_{s} , {f}_{s} ) \qquad [ Equation 11 ]$$

y_{q} (tₛ, fₛ) is a received signal vector when a signal is transmitted by the q-th antenna on a sampled resource (ts, fs), ĥ_{q} (tₛ, fₛ) is a wireless channel vector when a signal is transmitted by the q-th antenna on the resource (ts, fs), and n_{q} (tₛ, fₛ) denotes a noise vector when a signal is transmitted by the q-th antenna on the resource (ts, fs).

A frequency domain and a frequency resource (fs) may be defined as in the following equation.

$${f}_{s} ∈ [ 0 , δ f , … , ( {N}_{RB} - 1 ) δ f ] \qquad [ Equation 12 ]$$

Here, NRB is the number of RBs in a channel bandwidth, and δf indicates a frequency size corresponding to one RB. For example, in a case of LTE, δf is equal to 180 kHz. In addition, for example, in a case of NR, δf may be determined to vary according to a configured numerology.

A time domain and a time resource (ts) may be defined as in the following equation.

$${t}_{s} ∈ [ 0 , Δ T , … , ( {N}_{SRS} - 1 ) Δ T ] \qquad [ Equation 13 ]$$

Here, ΔT may refer to an SRS period (periodicity), and N_{SRS} indicates a count consumed during total cycles. The time domain expressed by an SRS is an example, and at the time of channel estimation using a CRS or a CSI-RS, a period and a scale in the time domain may be separately configured by higher layer signaling (e.g., CSI report configuration).

A channel response ĥ_{q} (tₛ, fₛ) of a two-dimensional resource structure (time-frequency resource) of the q-th antenna may be defined as follows by being vectorized, and when vectorization of ĥ_{q}(t₅, f₅) is performed first in the frequency domain and secondly in the time domain, same may be expressed as in the following equation.

$${\tilde{h}}_{q} = vec \{ {\hat{h}}_{q} ( {t}_{s} , {f}_{s} ) \} , {\tilde{y}}_{q} = vec \{ {\hat{y}}_{q} ( {t}_{s} , {f}_{s} ) \} , \qquad [ Equation 14 ]$$

Thereafter, each channel vector may be expressed by a non-linear function of channel parameters. For example, each channel vector may be expressed as in the following Equation.

$${\tilde{h}}_{q} = vec \{ {\hat{h}}_{q} ( t , k ) \} = {s}_{q} ( τ , v , {γ}_{q} ) = B ( τ , v ) \cdot {γ}_{q} = {B}_{tf} ( τ , v ) ⋄ {B}_{f} ( τ ) \cdot {γ}_{q} \qquad [ Equation 15 ]$$

Here, a parameter vector T, ν∈ [symbol] denotes a vector each having P number of real numbers, Y_{q} E [symbol] ^{P} indicates a vector having P number of complex numbers, and an operator “o” represents a Khatri-Rao product that is a column-wise Kronecker product. An example for two 2×2 matrixes of a Khatri-Rao product is as follows.

$$A ⋄ B = [ \begin{matrix}{a}_{11} & {a}_{12} \\ {a}_{21} & {a}_{22}\end{matrix} ] ⋄ [ \begin{matrix}{b}_{11} & {b}_{12} \\ {b}_{21} & {b}_{22}\end{matrix} ] = [ \begin{matrix}{a}_{11} {b}_{11} & {a}_{12} {b}_{12} \\ {a}_{11} {b}_{21} & {a}_{12} {b}_{22} \\ {a}_{21} {b}_{11} & {a}_{22} {b}_{12} \\ {a}_{21} {b}_{21} & {a}_{22} {b}_{22}\end{matrix} ] \qquad [ Equation 16 ]$$

In addition, the matrix B(t) may refer to an intra-band frequency response affected by path delay τ, B_{f}(τ) ∈ [symbol] ^{M}^{_{f}}^{×P} is given, and a mapping relation between input and output variables is equal to [symbol] ^{P}→ [symbol] ^{M}^{_{f}}^{×P}. Herein, Mf is the number of RBs in a corresponding subband. For example, the matrix B_{f}(τ) denotes an intra-subband SRS frequency response caused by path delay, and [B_{f}(τ)]_{P} that is a p-th column may be expressed by the following Equation.

$${[ {B}_{f} ( τ ) ]}_{p} = {e}^{- j 2 π {x}_{1} δ f {τ}_{p}} , \\ where {x}_{1} = {[ - ⌊ \frac{{M}_{f}}{2} ⌋ , - ⌊ \frac{{M}_{f}}{2} ⌋ + 1 , … , - ( ⌊ \frac{{M}_{f}}{2} ⌋ - 1 ) ]}^{T} \qquad [ Equation 17 ]$$

Similarly, the matrix B_{tf}(τ, v)∈ [symbol] ^{N}^{_{SRS}}^{×P} means a inter-band frequency response, and is a function of a path delay vector T and a Doppler vector v. A mapping relation between input and output variables of the function is ( [symbol] ^{P}, [symbol] ^{P})→ [symbol] ^{M}^{_{f}}^{×P}, and N_{SRS} indicates the number of SRS subbands simultaneously stored and processed in a buffer. [B_{tf}(τ, ν)]ₚ that is a p-th column of the matrix Bₜf(T, v) may be expressed as follows.

$${[ {B}_{tf} ( τ , ν ) ]}_{p} = {e}^{- j 2 π ( m Δ f {τ}_{p} - n Δ t {v}_{p} )} \qquad [ Equation 18 ]$$

Here, Δf denotes an inter-band frequency interval (e.g., 24 RBs * 180 KHz in LTE), and At denotes a sampling interval between adjacent SRS subbands. m denotes a band index, and n indicates a time index. According to an embodiment, d f and m are dependent on a communication system (e.g., LTE or NR), a subcarrier spacing (SRS), and a band position, and Lit and n may be dependent on a CSI configuration (e.g., CSI resource configuration (CSI-RS configuration) or CSI report configuration) or an SRS configuration configured by a network. If an SRS hopping pattern is configured, m and n may be determined according to the hopping pattern.

For the efficiency of signal processing and parameter estimation, q-th vectors h_{q} and y_{q} may be expressed, as in the following equation, as an overall vector connected through concatenation.

$$\tilde{h} = vec \{ [ {\tilde{h}}_{q = 1} , {\tilde{h}}_{q = 2} , … , {\tilde{h}}_{q = {N}_{a n t}} ] \} \tilde{y} = vec \{ [ {\tilde{y}}_{q = 1} , {\tilde{y}}_{q = 2} , … , {\tilde{y}}_{q = {N}_{a n t}} ] \} \qquad [ Equation 19 ]$$

In various embodiments, a vector signal model for an SRS described above may be expanded to consider multiple base station antennas (Nₐₙₜ). In this case, path delay and Doppler may be assumed to be common for the Nₐₙₜ number of antennas. A channel vector in Equation 15 above may be expressed as in the following Equation.

$$\tilde{h} = S ( τ , ν , γ ) = Γ ⋄ {B}_{t f} ⋄ {B}_{f} \cdot 1 \qquad [ Equation 20 ]$$

Here, a channel vector \tilde{h}=ΓoB_{tf}oB_{f}·1 is expressed by a non-linear function s( . . . ) for channel parameters {τ, ν, y_{q}}, Γ is a path weight matrix having the dimension Nₐₙₜ×P. and each row includes a path weight for one antenna. 1 denotes an overall column vector having a dimension of P×1.

More specifically, the channel vector may be expressed by a sum of column vectors for each path. For example, the channel vector may be expressed as in the following Equation.

$$\tilde{h} = {\sum }_{i = 1}^{P} {Γ}_{i} ⊗ {B}_{tf , i} ⊗ {B}_{f , i} = [ \begin{matrix}{γ}_{11} {B}_{1} + {γ}_{12} {B}_{2} + … {γ}_{1 P} {B}_{P} \\ {γ}_{21} {B}_{1} + {γ}_{22} {B}_{2} + … {γ}_{2 P} {B}_{P} \\ ⋮ \\ {γ}_{{N}_{ant} 1} {B}_{1} + {γ}_{{N}_{ant} 2} {B}_{2} + … {γ}_{{N}_{ant} P} {B}_{P}\end{matrix} ] \qquad [ Equation 21 ]$$

Here, Bₚ=B_{tf,p} ⊗B_{f,p} is given, and Bₚ denotes a p-th column of B(B=B_{tf}o B_{f}).

In consideration of the above parameters, variables of parameters defining the channel vector may include τ, ν, and Γ. That is, the purpose of channel estimation is finally defined to optimize a target function having channel parameters (τ, ν, Γ) as parameters. For example, in consideration of the above channel vector, channel estimation may include a method of obtaining the channel parameters (τ, ν, Γ) satisfying the following equation.

$${min}_{τ , ν , Γ} {‖ \tilde{h} - \tilde{y} ‖}^{2} = {min}_{τ , ν , Γ} {\sum }_{q = 1}^{{N}_{a n t}} {‖ {\tilde{h}}_{q} - {\tilde{y}}_{q} ‖}^{2} \qquad [ Equation 22 ]$$

In the above system model, examples of channel parameters required for channel estimations have been described. In this case, in various embodiments, an SRS or CSI being damaged by Gauss noise according to white noise may be considered, and the noise may be given by a zero mean complex Gaussian following a covariance matrix of N₀I. As described above, channel information directly estimated from an SRS or channel information reconstructed from a PMI has large dimensionality, and thus requires a high-complexity algorithm in tracking or predicting a channel using a linear filter such as a Kalman filter.

According to an embodiment, as shown in Equation 22-1, channel information may be expressed by linear and non-linear functions including an SD parameter θ, an FD parameter T, a Doppler parameter v, and a linear combination coefficient γ.

$${min}_{τ , ν , θ , Γ} {‖ \tilde{h} - \tilde{y} ‖}^{2} \qquad [ Equation 22 - 1 ]$$

That is, a non-linear function (s) according to channel parameters (τ, ν, γ) may be considered for a reception signal vector other than a channel vector. For example, a reception signal vector may be expressed as in the following equation.

$$\tilde{y} = \tilde{h} + {n}_{0} = s ( τ , ν , θ , γ ) \qquad [ Equation 23 ]$$

In FIG. 8, parameters of a wireless channel and a system model for performing channel estimation have been described. Hereinafter, operations of a channel estimation device (e.g., base station) for predicting the above parameter will be described in greater detail below with reference to FIG. 9.

FIG. 9 is a diagram illustrating an example operation for estimating a channel, based on a Kalman filter according to various embodiments. For example, FIG. 9 illustrates a flow of an operation for reconstructing and predicting channel information by, after CSI parsing is applied, predicting a channel coefficient from accumulated channel coefficients having a low dimension (dimensionality) using a Kalman filter, or by, after CSI parsing, extracting a channel parameter based on a Kalman filter from accumulated channel coefficients having a low dimension (dimensionality). As a channel parameter, at least one of channel parameters of a system model mentioned with reference to FIG. 8 may be used. Hereinafter, a situation where a base station estimates a downlink channel between a UE and the base station is described as an example.

Referring to FIG. 9, channel parameter prediction according to various embodiments of the disclosure may include two operations.

### 1) Acquisition of Channel Parameter Based on Kalman Filter (Operation 910)

The base station may perform Kalman filter-based channel estimation. The base station may perform Kalman filter-based channel estimation, based on channel information and resource information. That is, inputs for UKF-based channel estimation may include channel information and resource information. According to an embodiment, the Kalman filter may further include an EKF or UKF as well as a linear Kalman filter.

### 1) Channel Information

Channel information according to various embodiments may be obtained in various methods. The base station may obtain channel information before performing a channel estimation procedure. The obtained channel information is stored in a buffer. The buffer may include an SRS buffer or a CSI buffer. The SRS buffer may store a reception value for SRSs or channel estimation values based on an SRS. The CSI buffer may include pieces of CSI received from the UE. In addition, the channel information may include noise information.

Channel information may be obtained in various methods. According to various embodiments of the disclosure, the base station may perform channel estimation, based on SRSs received from the UE. In a TDD system, channel reciprocity is assumed. That is, estimation of a downlink channel from an uplink signal is possible. The base station may perform SRS-based channel estimation in a TDD system. At this time, an SRS transmission period, the position of a resource on which an SRS is transmitted (e.g., a time resource or a frequency resource), the number of antennas of the UE transmitting an SRS, and whether beamforming of an SRS is performed (e.g., SRS resource indicator (SRI)) may be determined based on SRS configuration information transmitted by the base station to the UE. The base station may determine an SRS configuration of the UE to perform smooth channel estimation.

According to various embodiments of the disclosure, the base station may perform channel estimation, based on CSI received from the UE. The base station may transmit a cell-specific reference signal (CRS) or CSI-reference signal (RS) signal to the UE. The UE may generate CSI, based on received CSI or CSI-RSs. The CSI may include various parameters. The CSI may include at least one of a CSI-RS resource indicator (CRI), a rank indicator (RI), a precoding matrix indicator (PMI), a channel quality indicator (CQI), or a layer indicator (Li). The CRI indicates a resource of a CSI-RS related to a preferred beam. The RI indicates information related to a rank of a channel, and denotes the number of streams received by the UE through the same resource. The PMI may indicate a precoding matrix recommended to the base station when layers, the number of which is notified by the RI, are used. The PMI is a value reflecting a spatial characteristic of a channel, and the UE may indicate the recommended precoding matrix in a form of an index. The precoding matrix may be stored in each of the base station and the UE in a form of a codebook including multiple complex weights. The CQI indicates a modulation scheme and a code rate relating to PDSCH transmission which may be received at a block error rate (BLER) equal to or smaller than a predetermined value, when the RI and PMI recommended by the UE are used.

The base station may perform channel estimation, based on CSI received from the UE. In order to more correctly predict parameters required for channel estimation, the base station may configure CSI in a required method. A CSI configuration may include at least one of a CSI measurement configuration, a CSI report configuration, and a CSI-RS configuration. The base station may adaptively generate a CSI configuration according to a required channel estimation method and transmit the generated CSI configuration to the UE through RRC signaling.

In a case of an LTE system, while a CRS is an always transmitted signal (always-on signal), CSI may be periodically or aperiodically reported. In addition, a CSI-RS may also be periodically or aperiodically transmitted. The base station may predict a channel from periodically received CSI, and according to an embodiment, may request aperiodic CSI reporting as needed (e.g., CSI reporting on a physical uplink shared channel (PUSCH)). In a case of an NR system, CSI and a CSI-RS have more flexible designs. That is, a CSI-RS may be periodically, semi-persistently, or aperiodically transmitted. In addition, the base station may configure the UE to periodically, semi-statically, or aperiodically report CSI. The base station may predict a channel, based on a periodic CSI-RS and a periodic CSI report, and according to an embodiment, may reconfigure a CSI-RS and a CSI report as needed. That is, in the disclosure, periodic transmission and periodic reporting are described as an example, but these merely correspond to an example, and CSI-RS transmission and CSI reporting may be configured in various methods.

The base station (e.g., gNB or eNB) has difficulty in obtaining channel information on all time-frequency resources, and thus may receive only CSI for a partial resource area. For example, a CRS of LTE is transmitted over all bands, but supports only up to four antennas. Therefore, smooth channel estimation is difficult in an 8Tx or more antenna environment after LTE Release 10, and a CSI-RS is also not transmitted over all bands. That is, the base station obtains only sampled channel information specified by some times (e.g., a unit of slots) or some frequencies (e.g., a unit of RBs) among all resources, and thus accurate channel estimation is difficult.

According to the above embodiments, a technique relating to CSI channel prediction at a low dimension has been described based on a linear Kalman filter. However, a non-linear Kalman filter may be considered to extract a Doppler parameter, which is a non-linear component, and perform improved CSI prediction. According to an embodiment, an EKF method may enable a non linear function for channel parameters to be transformed (linearized) into a linearization function through approximation. Specifically, an EKF may linearize a non-linear function through Taylor approximation. According to an embodiment, a UKF method supplementing the EKF method may be further considered, and the UKF method prevents/reduces loss of statistical information of a second order or higher and enables smooth prediction of channel information changing on time-frequency according to the movement of the UE. Accordingly, the base station may estimate, in advance, a channel corresponding to a current time, based on the UKF method using, as an input, channel information (e.g., raw channel information (CSI or SRS) obtained from the UE, thereby providing more robust precoding and scheduling to the UE. According to an embodiment, the base station may estimate a channel in advance every scheduling unit (TTI) (e.g., slot).

### 2) Resource Information

Resource information according to various embodiments may be obtained variously. In various embodiments, resource information may include a current time-frequency resource (ts, fs). In addition, in various embodiments, resource information may include time information. Time information may include a period of periodically reported CSI reporting (periodic CSI reporting), the number of measurements, the number of CSI transmissions, the number of times of aperiodic CSI reporting, and a reporting time. In addition, in various embodiments, resource information may include frequency information. Frequency information may include an RB area (e.g., bandwidth part (BWP) information) in which channel estimation is performed on the frequency domain, a channel bandwidth, an SCS, a frequency hopping pattern, and a numerology. In addition, in various embodiments, resource information may include spatial information. Spatial information may include beam information (e.g., a beam index such as a CRI, SSBRI, or SRI), a QCL parameter (e.g., QCL type A, B, C, or D), and antenna port information.

According to various embodiments of the disclosure, an EKF may include a filter that linearizes each element of a non-linear system into a linear function through differentiation and returns the linearized function to a Kalman filter. In addition, an EKF may be performed based on the operation of FIG. 9 similarly to an UKF operation to be described below. In various embodiments of the disclosure, according to each situation and variable, at least one of a linear Kalman filter, an EKF, or a UKF may be adaptively selected and be performed. Hereinafter, applying a UKF to an LC weight in order to more effectively extract a Doppler parameter in addition to a linear Kalman filter and an EKF will be described in detail.

### 1-3. UKF-Based Channel Estimation

The base station may perform UKF-based channel estimation, based on channel information and resource information to obtain channel parameters. The base station may output the obtained parameters for a next operation 920. For example, the base station may obtain a channel parameter for each path. A parameter for each channel may include a delay parameter (τ), a Doppler parameter (ν), and a complex weight (γ_{q}). According to an embodiment, the delay parameter and the Doppler parameter may have a value changing according to a path (p). In addition, according to an embodiment, the complex weight is a channel parameter reflecting a spatial weight and may be a function of an antenna (q) and a path (P). In addition, for example, a parameter for each channel may include an amplitude (α) and a phase (ϕ). These parameters may be used for a Type II codebook defined in 3GPP. When the UE transmit Type II codebook-based PMI feedback, the base station may more effectively estimate a channel vector through corresponding parameters. In addition, for example, a parameter for each channel may further include a change rate Δτₖ of path delay and a change rate Δνₖ of Doppler.

Acquisition of a channel parameter based on a non-linear Kalman filter may refer, for example, to a process of acquiring channel parameters of state vectors defining a channel using an EKF or UKF (hereinafter, for convenience, description will be provided using a UKF as an example). Various channel parameters may be defined according to how the base station configures a state vector defining a channel. For example, channel parameters may include at least one of parameters related to a system model described with reference to FIG. 8.

A UKF may be a type of Kalman filter. A Kalman filter is a recursive filter for estimating a state of a linear model, based on a measured value including noise, and is used to estimate a combination distribution of a current state value (or state vector), based on a measured value obtained in the past. Here, a recursive algorithm of the Kalman filter may include two stages of prediction and update. In the predict stage, the base station predicts a current state vector and accuracy. Thereafter, after the current state vector is actually measured, in the update stage, the base station updates the current state vector by reflecting the difference between an actual measured value and a measured value predicted based on a previously estimated state vector. Although not illustrated in FIG. 9, such an update stage may be re-performed every time a CSI buffer or SRS buffer is updated or a resource configuration is changed (e.g., a numerology is changed). According to an embodiment, the update stage may be performed less frequently than predicted. In addition, according to an embodiment, the update stage may be performed at the same frequency as predicted.

Meanwhile, Kalman filters are based on a linear model, and thus it is not easy to apply, without change, a Kalman filter to a non-linear model, such as a channel that changes according to time resources, frequency resources, or spatial resources. If a state transition and observation model (prediction and update function) is very not linear, it may be difficult to expect efficient performance improvement with only a linear Kalman filter. An EKF method designed according thereto is a method of performing Taylor series and linearization approximation for a non-linear function including a parameter required to be estimated, and introducing the function into a Kalman filter operated based on a linear function, so as to track the parameter in the non-linear function.

However, in order to more correctly reflect secondary elements in a linearization approximation process, a base station according to various embodiments may perform channel estimation based on a UKF. In comparison with an extended Kalman filter (EKF) method capable of estimating a channel parameter in a non-linear function, a UKF method may indicate a method for a combination of, with a Kalman filter, a uniform transform (UT) capable of precisely selecting a) 2n+1 number of samples (sigma points) called sigma points and 2) weights (W) of the samples. In a UKF, a deterministic sampling technique known as unscented transform is used to obtain a minimal set of sample points around a mean. Sigma points are transferred through a non-linear function, and the mean and covariance are calculated for the transformed points. By predicting a state vector, based on sigma points, the base station may obtain a more accurate channel estimation result.

### 3) Channel Prediction (Operation 920)

The base station may perform channel estimation. Here, channel prediction is a procedure of predicting a channel at a time point after acquisition of channel information, according to predicted channel parameters, that is, a state vector value. The base station may determine an actual channel (e.g., h_{q}(f, t) of Equation 10) on a current time-frequency resource, based on the channel information and the state vector. The channel may be expressed as a non-linear function of the channel parameters. The channel parameters may be parameters configuring the state vector. The base station may determine a final channel vector, based on a model (e.g., Equation 15 or Equation 20) using a non-linear function, from the state vector. The base station may determine channel vectors, based on an output before next channel information (e.g., CSI buffer or SRS buffer) is updated.

For example, when a system model of FIG. 8 is assumed, a channel may be based on a maximum of P number of basis waveforms. For example, P number of sinusoidal waveforms indexed by {p=1, 2, . . . , P} are used, and each signal is parameterized by a p-th signal delay τₚ and a p-th signal Doppler shift νₚ. The base station may receive, as an input, a sample in a CSI buffer or SRS buffer, and derive a signal delay, a Doppler shift, and a combination weight. Thereafter, the base station may output a linear combination of the P number of basis waveforms, as a predicted channel at time t and frequency f. The base station may predict a channel in real time before Equations 12 and 13 and next channel information (e.g., CSI buffer or SRS buffer) are updated.

According to various embodiments of the disclosure, CSI prediction based on a Kalman filter may be performed based on at least one of all, some, or a combination of some of operations according to FIG. 1 to FIG. 9. Specifically, CSI reconstruction may be performed by performing a linear combination sum using an SD/FD basis and filtered nonzero linear combination (LC) coefficient values extracted according to the above examples. In addition, predicted CSI for each slot may be efficiently extracted, through an auto-regressive (AR) filtering technique, from a secondary statistic extracted by configuring the reconstructed CSI as a statistical prediction value of a predicted channel and interpreting reported CSI in a current state as a measured value.

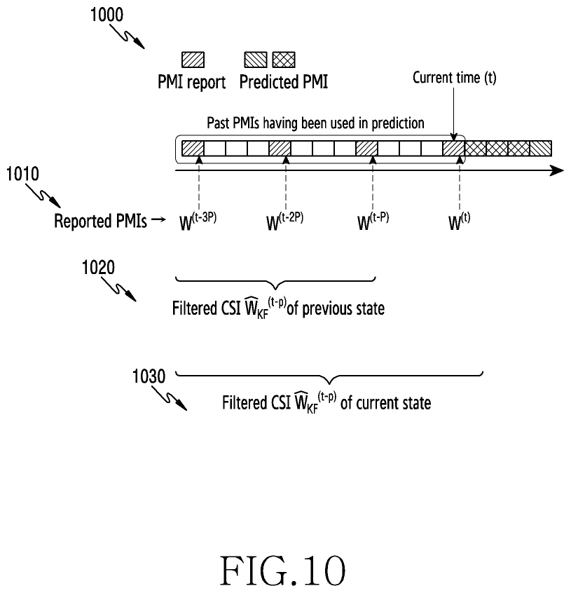

FIG. 10 is a diagram illustrating an example of channel prediction based on a Kalman filter according to various embodiments. For example, referring to FIG. 10, a history of PMIs having been used for prediction, a PMI measured based on a current time, and a predicted PMI are illustrated in a time sequence (1000).

According to an embodiment, according to Equation 9 described above, a matrix relating to a PMI reported at a previous time (t−P) may be expressed as follows.

$${W}^{( t - P )} = \frac{1}{\sqrt{{N}_{1} {N}_{2} {γ}_{l}}} = [ \begin{matrix}{\sum }_{i = 0}^{L - 1} {\sum }_{f = 0}^{{M}_{v} - 1} {c}_{i , f}^{( t - P )} {v}_{{m}_{1 , ( t - P )}^{( i )} , {m}_{2 , ( t - P )}^{( i )}} {y}_{( t - P )}^{{( f )}^{H}} \\ {\sum }_{i = 0}^{L - 1} {\sum }_{f = 0}^{{M}_{v} - 1} {c}_{i + L , f}^{( t - P )} {v}_{{m}_{1 , ( t - P )}^{( i )} , {m}_{2 , ( t - P )}^{( i )}} {y}_{( t - P )}^{{( f )}^{H}}\end{matrix} ]$$

According to an embodiment, according to Equation 9 described above, a matrix relating to a PMI reported at a current time (t) may be expressed as follows.

$${W}^{( t )} = \frac{1}{\sqrt{{N}_{1} {N}_{2} {γ}_{l}}} [ \begin{matrix}{\sum }_{i = 0}^{L - 1} {\sum }_{f = 0}^{{M}_{v} - 1} {c}_{i , f}^{( t )} {v}_{{m}_{1 , ( t )}^{( i )} , {m}_{2 , ( t )}^{( i )}} {y}_{( t )}^{{( f )}^{H}} \\ {\sum }_{i = 0}^{L - 1} {\sum }_{f = 0}^{{M}_{v} - 1} {c}_{i + L , f}^{( t )} {v}_{{m}_{1 , ( t )}^{( i )} , {m}_{2 , ( t )}^{( i )}} {y}_{( t )}^{{( f )}^{H}}\end{matrix} ]$$

Referring to FIG. 10, as an example of reported PMIs 1010, in relation to the matrixes W^{(t-3P)}, W^{(t-2P)}, W^{(t-P)}, a W_{KF}^{(t-P)} value 1020 that is a filtered CSI value of a previous state may be obtained, and a Ŵ_{KF}^{(t)} value 1030 that is a filtered CSI value of a current state may be obtained based on the above pieces of information.

According to various embodiments of the disclosure, as the moving speed of a UE increases, there is a possibility that an SD/FD basis set may be more frequently changed. According to an embodiment, in an environment described above, in order to design PMI channel prediction to have low complexity, it is required to use parsed PMI index information to use a low-dimensional matrix of linear combination weights. In addition, it is required to reflect a new rotation orthogonal basis of an updated PMI in the current state, and use a low-dimensional matrix of Kalman-filtered linear combination weights of a previous state.

Based on the above description, in relation to \tilde{C}₂ of a previous or current state, a Kalman-filtered LD weight related to the previous state may be expressed as follows.

$${( t - P )}^{} = \frac{1}{\sqrt{{N}_{1} {N}_{2} {γ}_{l}}} = [ \begin{matrix}{\sum }_{i = 0}^{L - 1} {\sum }_{f = 0}^{{M}_{v} - 1} {\tilde{c}}_{i , f}^{( t - P )} {v}_{{m}_{1 , ( t - P )}^{( i )} , {m}_{2 , ( t - P )}^{( i )}} {y}_{( t - P )}^{{( f )}^{H}} \\ {\sum }_{i = 0}^{L - 1} {\sum }_{f = 0}^{{M}_{v} - 1} {\tilde{c}}_{i + L , f}^{( t - P )} {v}_{{m}_{1 , ( t - P )}^{( i )} , {m}_{2 , ( t - P )}^{( i )}} {y}_{( t - P )}^{{( f )}^{H}}\end{matrix} ]$$

In relation to \tilde{C}₂ of a previous or current state, a Kalman-filtered LD weight related to the current state may be expressed as follows.

$${( t )}^{} = \frac{1}{\sqrt{{N}_{1} {N}_{2} {γ}_{l}}} [ \begin{matrix}{\sum }_{i = 0}^{L - 1} {\sum }_{f = 0}^{{M}_{v} - 1} {\tilde{c}}_{i , f}^{( t )} {v}_{{m}_{1 , ( t )}^{( i )} , {m}_{2 , ( t )}^{( i )}} {y}_{( t )}^{{( f )}^{H}} \\ {\sum }_{i = 0}^{L - 1} {\sum }_{f = 0}^{{M}_{v} - 1} {\tilde{c}}_{i + L , f}^{( t )} {v}_{{m}_{1 , ( t )}^{( i )} , {m}_{2 , ( t )}^{( i )}} {y}_{( t )}^{{( f )}^{H}}\end{matrix} ]$$

Based on the above description, specific operations enabling channel prediction of reduced complexity and a low dimension using \tilde{C}₂ will be described below.

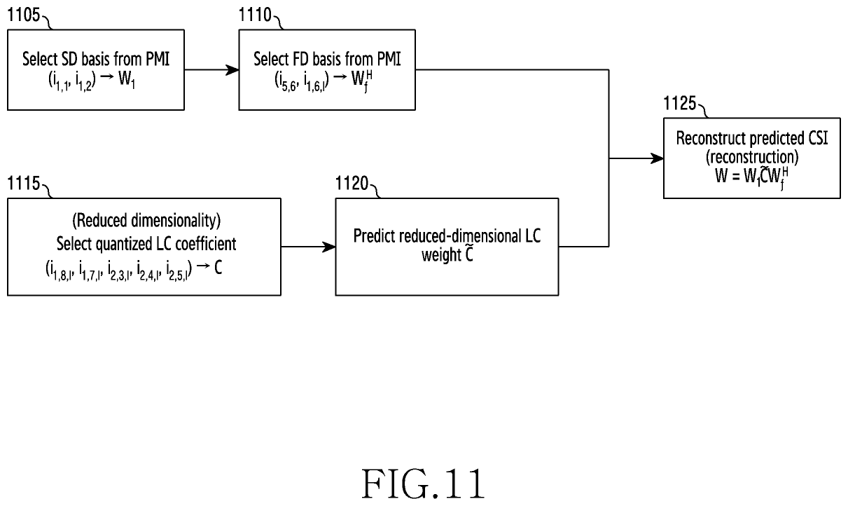

FIG. 11 is a diagram illustrating an example operation for predicting a channel at low complexity in a case of a UE moving at a low speed according to various embodiments. According to an embodiment, when a UE is moving at a relatively low speed (e.g., 0-6 km/h), an SD basis and an FD basis may denote almost fixed parameters, and an LC weight may denote a slowly changing parameter. Therefore, a CSI channel estimation device including a base station may parse a PMI, based on a received CSI report, and perform an operation accordingly.

In operation 1105, a base station may select an SD basis from a PMI. The base station may identify a precoding matrix element Wᵢ from PMI indexes (i_{1,1}, i_{1,2}) related to the SD basis.

In operation 1110, a base station may select an FD basis from the PMI. The base station may identify a precoding matrix element W_{f}^{H} from PMI indexes (i_{1,5}, i_{1,6,1}) related to the FD basis.

In operation 1115, the base station may select a low-dimensional quantized linear combination (LC) coefficient. The base station may identify a precoding matrix element C from PMI indexes (i_{1,8,1}, i_{1,7,1}, i_{2,3,1}, i_{2,4,1}, i_{2,5,1}) related to a LC weight.

In operation 1120, the base station may identify a low-dimensional LC weight e, based on a Kalman filter, and perform channel prediction therefor.

In operation 1125, the base station may reconstruct predicted CSI according to W=W₁\tilde{C}W_{f}^{H}.

As described above, through the operation shown in FIG. 11, various embodiments enable CSI prediction of a low dimension and low complexity. More specifically, according to various embodiments of the disclosure, a UE moving at a low speed may, under the assumption that an SD/FD basis is maintained, distinguish operations relating to an SD/FD basis and a LC weight through PMI parsing and perform channel prediction in relation to the LC weight, thereby performing CSI estimation of low complexity and a low dimension.

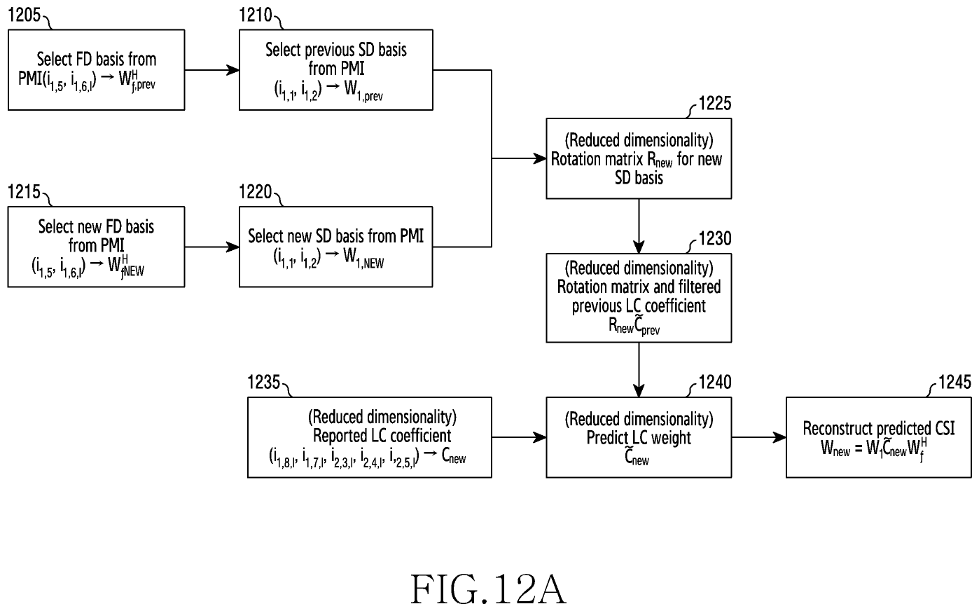

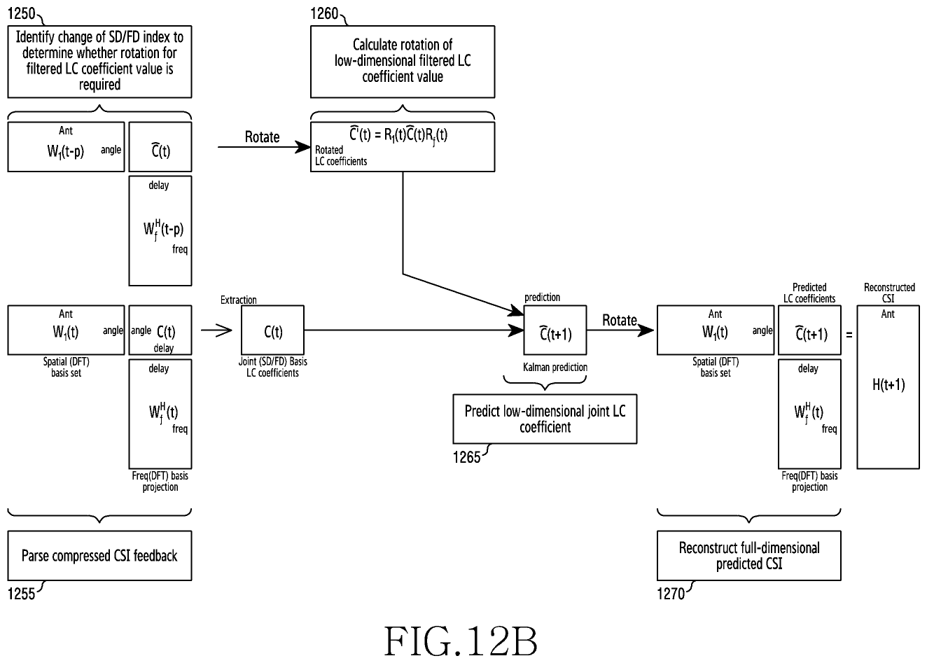

FIG. 12A is a diagram illustrating an example operation for predicting a channel at low complexity in a case of a UE moving at a high speed according to various embodiments. According to an embodiment, when a UE is moving at a relatively high speed, an SD basis, an FD basis, and an LC weight may indicate dynamically changing parameters. Therefore, a CSI channel estimation device including a base station may parse a PMI, based on a received CSI report, and extract parameters according to a previous state and a current state to perform an operation accordingly.

Although not illustrated in FIG. 11, according to an embodiment, the base station may identify a moving speed of the UE before performing channel estimation. The base station may compare the moving speed of the UE with a threshold to determine whether to generate a rotation matrix based on an SD basis and an FD basis. For example, if the UE is identified as moving a relatively low speed, an SD basis and an FD basis may be almost fixed and thus a separate rotation matrix is unnecessary. However, if the UE is identified as moving very fast, a change of an SD basis and an FD basis is required to be reflected on channel prediction, and thus a rotation matrix may be required.

According to an embodiment, the base station may compare PMI parsing values between a previous CSI report and a next CSI report through PMI parsing to detect, from an index change, whether an SD/FD basis set used in a previous/next state of a moving UE is changed, and may generate a rotation matrix obtained by pre-calculating a correlation between an SD basis and an FD basis at the time of SD/FD basis conversion.

In operation 1205, the base station may select an FD basis from a previous PMI. The base station may identify W_{f,prev}^{H} that is a precoding matrix element of a previous state from PMI indexes (i_{1,5}, i_{1,6,1}) related to the FD basis.

In operation 1210, the base station may select an SD basis from the previous PMI. The base station may identify a precoding matrix element W_{i,prev} from PMI indexes (i_{1,1}, i_{1,2}) related to the SD basis.

In operation 1215, the base station may select a new FD basis from a current PMI. The base station may identify W_{f,new}^{H} that is a precoding matrix element of a current state from PMI indexes (i_{1,5}, i_{1,6,1}) related to the FD basis.

In operation 1220, the base station may select a new SD basis from the current PMI. The base station may identify a precoding matrix element Wᵢ from PMI indexes (i_{1,1}, i_{1,2}) related to the SD basis.

In operation 1225, the base station may generate a rotation matrix R_{new}, based on a changed value of parameters obtained in operation 1205 to operation 1220. According to an embodiment, the rotation matrix R_{new} may be a rotation matrix relating to a new SD basis. Specifically, since oversampling exists in an SD basis unlike an FD basis, orthogonality may not be satisfied between SD basis sets, and thus a rotation matrix based on an SD basis may be generated.

In operation 1230, the base station may identify a R_{new}\tilde{C}ₚᵣₑᵥ value by applying the rotation matrix R_{new} to a value obtained by applying a filtered previous LC weight and Kalman filtering. As a precondition therefor, the base station may have obtained the filtered previous LC weight from a previous CSI report and have performed Kalman filter.

In operation 1235, the base station may select a low-dimensional quantized linear combination (LC) coefficient from the current PMI. The base station may identify a precoding matrix element C from PMI indexes (i_{1,8,1}, i_{1,7,1}, i_{2,3,1}, i_{2,4,1}, i_{2,5,1}) related to a LC weight.

In operation 1240, the base station may identify \tilde{C}_{new} that is a prediction value of an LC weight. For example, the base station perform Kalman filtering, based on the R_{new}\tilde{C}ₚᵣₑᵥ value to which the rotation matrix has been applied, and C_{new} obtained from the current PMI, and obtain a \tilde{C}_{new} value accordingly. According to an embodiment, a rotation matrix adjusts a filtered LC weight value expressed on an SD/FD basis axis in a previous state, to be expressed as LC weight values expressed on the SD/FD basis axis in a current state, so as to apply a Kalman filter together with LC weight values extracted through PMI parsing in the current state, based on the values expressed on the same axis, whereby efficient CSI prediction may be performed. In addition, according to an embodiment, when an EKF or UKF is used, a Doppler parameter that is a non-linear component mapped to the SD/FD basis axis may also be extracted other than LC weight values, and thus more accurate CSI prediction is possible.

In operation 1245, the base station may reconstruct predicted CSI according to W=W₁ [symbol] W_{f}^{H}. For example, the base station may perform CSI reconstruction (e.g., CSI decompression) by performing a linear combination sum based on the filtered LC weight values of the current state and the SD/FD basis in the current state.

Although not illustrated in FIG. 12A, the base station may, in addition to the above operations, extract efficiently a predicted CSI value for each slot, through an auto-regressive (AR) filtering technique, from a secondary statistic extracted by configuring the reconstructed CSI value as a statistical prediction value of a predicted channel and interpreting reported CSI in the current state as a measured value. When a Doppler parameter extracted through a non-linear Kalman filter is further used, high resolution PMI-based CSI prediction considering the mobility of a UE may also be performed at a low complexity and high efficiency.

FIG. 12B is a diagram illustrating an example operation for predicting a channel at low complexity in a case of a UE moving at a high speed according to various embodiments. Referring to FIG. 12B, an example CSI prediction operation is described.

In operation 1250, a base station may identify a change of an SD/FD index to determine whether a rotation matrix for a filtered LC coefficient value is required. According to an embodiment, the base station may select an FD basis from a previous PMI. The base station may identify W_{f,(t-p)}^{H} that is a precoding matrix element at a t-p time point from a PMI index related to the FD basis. In addition, the base station may select an SD basis from the previous PMI. The base station may identify a precoding matrix element W_{1,(t-p)} from a PMI related to the SD basis. Here, each column vector of W_{1,(t-p)} may represent an antenna and each row vector may represent an angle, and each column vector of W_{f,(t-p)}^{H} may represent a delay and each row vector may represent a frequency. In addition, an LC coefficient value \tilde{C}₍ₜ₎ may be calculated based on the elements, and the base station may identify SD/FD indexes based on the above matrixes to determine whether rotation for a matrix related to the LC coefficient value is required.

In operation 1255, the base station may parse compressed CSI feedback received at a current time point. According to an embodiment, the base station may select an FD basis from a current PMI. The base station may identify W_{f,(t)}^{H} that is a precoding matrix element at a t time point from a PMI index related to the FD basis. In addition, the base station may select an SD basis from the current PMI. The base station may identify a precoding matrix element W₁₍ₜ₎ from a PMI index related to the SD basis. The base station may extract an LC coefficient value Cₜ for a joint SD/FD basis component, based on the identified SD/FD bases.

In operation 1260, the base station may calculate a rotation matrix based on a low-dimensional filtered LC coefficient value. According to an embodiment, if it is determined that rotation for the LC coefficient value calculated in operation 1250 is required, the base station may calculate a rotation matrix therefor. A rotated LC coefficient value calculated based on the rotation matrix may be calculated by \tilde{C}′₍ₜ₎=R₁₍ₜ₎\tilde{C}₍ₜ₎R_{f(t)}. The rotation matrix has been described in detail with reference to FIG. 7 to FIG. 10.

In operation 1265, the base station may predict a low-dimensional joint LC coefficient value. According to an embodiment, the base station may apply a Kalman filter, based on the LC coefficient value Cₜ for the joint SD/FD basis component extracted in operation 1255, and the rotated LC coefficient \tilde{C}′₍ₜ₎ extracted in operation 1260. The base station may predict and calculate a low-dimensional predicted joint LC coefficient value \tilde{C}₍ₜ₊₁₎ according to the application of the Kalman filter.

In operation 1270, the base station may reconstruct predicted CSI of a full dimension (full dimensionality). According to an embodiment, the base station may reconstruct predicted CSI of a full dimension, based on the predicted joint LC coefficient value \tilde{C}₍ₜ₊₁₎. More specifically, the base station may obtain a reconstructed CSI matrix H₍ₜ₊ₗ₎ by applying the predicted joint LC coefficient value \tilde{C}₍ₜ₊₁₎ to the SD basis-related W_{1,(t)} and the FD basis-related W_{f,(t)}^{H} obtained from the current PMI.

Although not illustrated in FIG. 12B, the base station may, in addition to the above operations, extract efficiently a predicted CSI value for each slot, through an auto-regressive (AR) filtering technique, from a secondary statistic extracted by configuring the reconstructed CSI value as a statistical prediction value of a predicted channel and interpreting reported CSI in the current state as a measured value. When a Doppler parameter extracted through a non-linear Kalman filter is further used, high resolution PMI-based CSI prediction considering the mobility of a UE may also be performed at a low complexity and high efficiency.

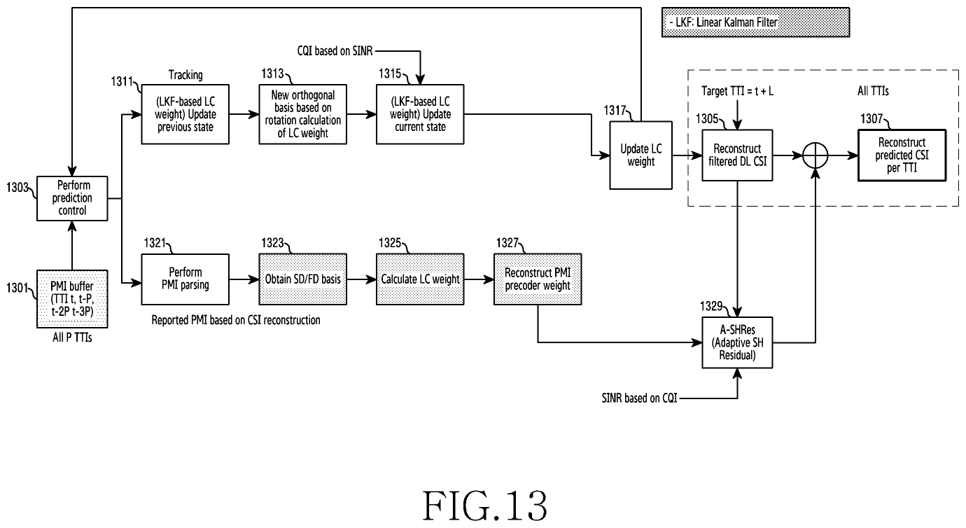

FIG. 13 is a diagram illustrating an example operation for predicting a channel, based on a linear Kalman filter (LKF) according to various embodiments. According to an embodiment, referring to FIG. 13, operation blocks for performing the operations and the contents given with reference to FIG. 1 to FIG. 12B are illustrated. However, the order and operations are illustrated for convenience, and the disclosure is not limited thereto. Various embodiments of the disclosure may also include a case where some of the operations illustrated in FIG. 13 are excluded or the order is changed, only if the case includes the technical features of the disclosure.

In operation 1301, a base station may include PMI information for each time point or TTI in a PMI buffer, based on received CSI.

In operation 1303, the base station may perform control for CSI prediction. Specifically, the base station may perform control for PMI parsing or LC weight update of a current state, based on an LC weight value updated in operation 1317 and the PMI information for each time point.

In operation 1311, the base station may update a previous state through an LC weight based on a linear Kalman filter (LKF), and in operation 1313, may obtain a new orthogonal basis, based on calculation of a rotation matrix of the LC weight. Accordingly, in operation 1315, the base station may update the current state, based on the LKF, and in operation 1317, may update information on the LC weight. Operations 1311 to 1317 particularly relate to an operation of LC weight update for CSI prediction, and the above operation and description related to FIG. 1 to FIG. 12B may be applied thereto.

In operation 1321, the base station may parse PMI parameters for each index, and in operation 1323, may obtain an SD/FD basis. In addition, in operation 1325, the base station may calculate and obtain an LC weight, based on the current state, and in operation 1327, may reconstruct a PMI precoder weight.

In operation 1329, the base station may perform an adaptive SH residual (A-SHRes) operation, based on the reconstructed PMI precoder weight and a filtered CSI reconstruction value. A-SHRes indicates an adaptive residual, and may include an operation of estimating a regression coefficient, based on the difference between an estimated regression formula and an actual observed value.

In operation 1305, the base station may obtain a filtered downlink CSI reconstruction value, and in operation 1307, may reconstruct predicted CSI for each TTI, based on the reconstruction value and a regression value obtained from operation 1329.

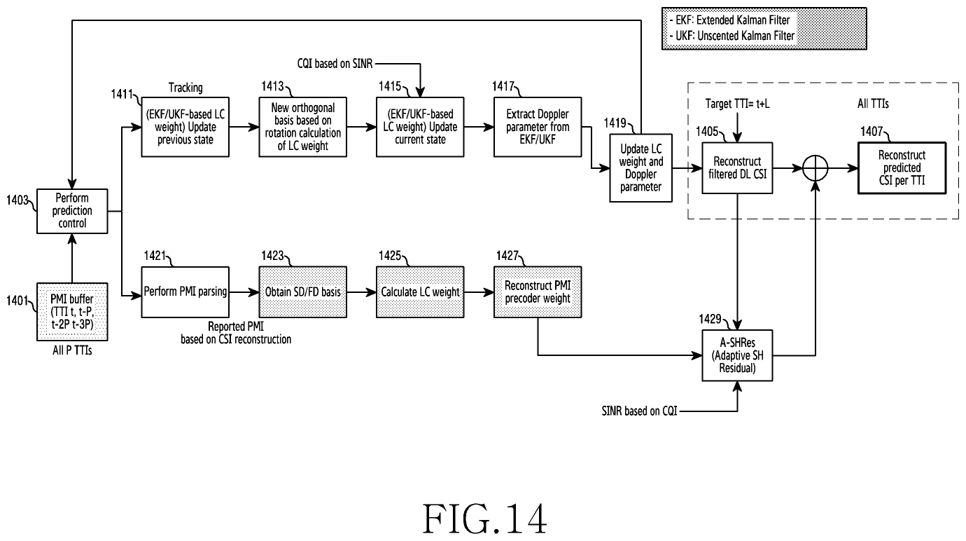

FIG. 14 is a diagram illustrating an example operation for predicting a channel, based on an extended Kalman filter (EKF) or an unscented Kalman filter (UKF) according to various embodiments of the disclosure. According to an embodiment, referring to FIG. 13, operation blocks for performing the operations and the contents given with reference to FIG. 1 to FIG. 12B are illustrated. However, the order and operations are illustrated for convenience, and the disclosure is not limited thereto. Various embodiments of the disclosure may also include a case where some of the operations illustrated in FIG. 13 are excluded or the order is changed, only if the case includes the technical features of the disclosure.

With reference to FIG. 14, operations similar to or substantially identical to FIG. 13 may be performed. For example, operation 1401 to operation 1407 may correspond to operation 1301 to operation 1307 of FIG. 13. However, FIG. 14 illustrates a channel prediction structure further considering a non-linear parameter, based on a non-linear Kalman filter, and thus an operation of extracting and updating a Doppler parameter may be further performed in addition to the operations in FIG. 13.

In operation 1417, a base station may extract a Doppler parameter, based on an EKF or UKF that is a non-linear Kalman filter. Therefore, accordingly, in operation 1419, the base station may further perform an operation of updating a Doppler parameter as well as an LC weight.

As described above, in FIG. 14, based on a non-linear Kalman filter, other than filtered LC weight values expressed as coefficients on a current state SD/FD basis axis, extraction of a Doppler parameter that is a non-linear component mapped to the SD/FD basis axis is also possible, and thus more accurate CSI prediction may be performed.

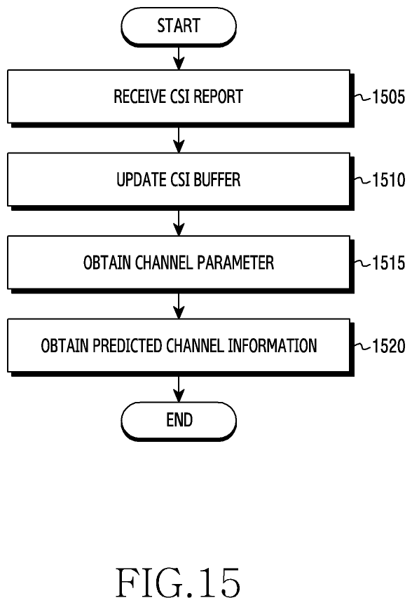

FIG. 15 is a flowchart illustrating an example operation for estimating a channel using channel state information (CSI) in a wireless communication system according to various embodiments. As a device that performs channel estimation, the base station 110 in FIG. 1 is used as an example.

In operation 1505, a base station may receive CSI. The base station may transmit a CRS or CSI-RS to a UE, and the UE may generate CSI, based on the CRS or CSI-RS. The UE may report the generated CSI to the base station. According to an embodiment, the UE may report the CSI at least one of periodically, semi-statistically, or aperiodically. The CSI may include a PMI. For example, the PMI may be a PMI for a configured entire bandwidth, that is, a wideband PMI. In addition, for example, the PMI may be a subband PMI. Hereinafter, in the disclosure, a PMI is used as an example of a CSI element for a channel vector, but other parameters of CSI may be used for channel estimation.

In operation 1510, the base station may update a CSI buffer. The CSI buffer may include a PMI buffer. The PMI buffer may include information on a PMI included in CSI. The base station may update the PMI buffer, based on the PMI obtained in operation 1505. According to an embodiment, the base station may manage the PMI buffer according to a time-frequency resource. For example, the base station may manage the PMI buffer in a unit of a particular frequency domain or time domain. Here, the particular frequency domain may be configured in a unit of at least one of a PRB, a physical resource block group (PRG), a subband, a bandwidth part (BWP), a channel bandwidth, and a carrier frequency. In addition, the time domain may be configured in a unit of a CSI-RS transmission period, a CSI reporting period, a TTI, and a period during which the same frequency domain is repeated.

In operation 1515, the base station may obtain a channel parameter. The base station may obtain a channel parameter, based on the CSI buffer (e.g., PMI buffer). The base station may obtain a channel parameter, based on a PMI for each time-frequency resource. A channel parameter according to various embodiments may be a parameter configuring a state vector (θₖ) to be applied to a Kalman filter. The parameter configuring the state vector may include at least one of channel parameters used as an example in the system model in FIG. 8 and FIG. 9. For example, a channel parameter may include at least one of a delay parameter, a Doppler parameter, a changed value of a delay parameter, a changed value of a Doppler parameter, and the amplitude and the phase of a signal. For example, the state vector at time to may be determined as in the following Equation.

$$θ ( {t}_{0} ) = [ τ , Δτ , v , Δ v , γ ] \qquad [ Equation 24 ]$$

In operation 1520, the base station may obtain predicted channel information. Predicted channel information may include channel vectors before next CSI (including a PMI) is received and channel information is updated after time interval to (e.g., if a period is T, from t₀ to t_{0+T}). The state vector has been updated based on the received PMI, and thus the base station may predict a current channel vector, based on previously obtained channel parameters before next CSI (or PMI) is received. The base station may derive predicted channel information (e.g., a channel vectors or channel parameters) in each time interval between t₀ and t_{0+T} (e.g., at each time of t₀₊₁, t₀₊₂, . . . , and t_{0+T-1}). For example, the base station may derive channel vectors according to the Equation below.

$${\hat{h}}_{θ ( {t}_{0} )} ( {t}_{0} + 1 , \{ f \} ) , … , {\hat{h}}_{θ ( {t}_{0} )} ( {t}_{0} + T - 1 , \{ f \} ) \qquad [ Equation 25 ]$$

[symbol] denotes a channel vector at a state vector (θₜ_{₀}), a time index t and a frequency index f.

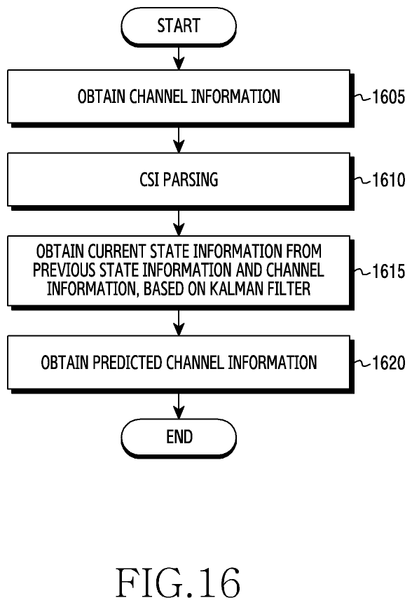

FIG. 16 is a flowchart illustrating an example operation for predicting a channel using channel state information (CSI) parsing and a channel parameter according to various embodiments. Referring to FIG. 16, according to various embodiments of the disclosure, at least some of the predicted channel information obtained in FIG. 15 may be used. Hereinafter, as a device that performs channel estimation, the base station 110 in FIG. 1 is used as an example.

In operation 1605, a base station may obtain channel information. The base station may obtain channel information on a downlink channel between a UE and the base station. According to an embodiment, the base station may receive CSI. The base station may transmit a CRS or CSI-RS to the UE, and the UE may generate CSI, based on the CRS or CSI-RS. The UE may report the generated CSI to the base station. According to an embodiment, the UE may report the CSI at least one of periodically, semi-statistically, or aperiodically. The CSI may include a CRI, an RI, a PMI, a CQI, or an LI. For example, the PMI may be a PMI for a configured entire bandwidth, that is, a wideband PMI. In addition, for example, the PMI may be a subband PMI. According to an embodiment, the channel information obtained by the base station in FIG. 16 may include at least one of channel information at a previous time point or channel information at a current time point. Hereinafter, in the disclosure, a PMI is used as an example of a CSI configuration element for deriving a channel vector, but other CSI elements may be used for channel estimation. The base station may obtain channel information on a downlink channel, based on CSI received from the UE. The base station may obtain channel information at time point to. The channel information indicates a state of a downlink channel at time point to.

In operation 1610, the base station may perform CSI parsing. According to various embodiments of the disclosure, the base station may perform PMI parsing, based on the received channel information. The base station may obtain values related to an SD basis or FD basis as a result of the PMI parsing. According to an embodiment, the base station may identify a set of SD/FD bases as at least one of a changed set or a non-changed set. According to an embodiment, the base station may compare each PMI parsing value according to a previous CSI report and a current CSI report, based on the PMI parsing. The base station may identify whether each SD/FD basis related to a previous state or a current state is changed, according to a change of an index, based on a result of the comparison. If the SD/FD basis is changed, the base station may generate a rotation matrix obtained by pre-calculating a correlation therebetween. According to an embodiment, the base station may store the generated rotation matrix in a form of a lookup table (LUT). According to an embodiment, the rotation matrix generated by the base station may be a rotation matrix relating to a new SD basis. Specifically, since oversampling exists in an SD basis unlike an FD basis, orthogonality may not be satisfied between SD basis sets, and thus a rotation matrix based on an SD basis may be generated.

According to various embodiments of the disclosure, the base station may perform PMI parsing, based on the received channel information. The base station may obtain values related to an LC weight as a result of the PMI parsing. The LC weight obtained by the base station has been described in detail with reference to FIG. 7.

In operation 1615, the base station may obtain previous or current state information, based on a Kalman filter. The base station may obtain current state information from previous state information and the received channel information, based on the Kalman filter. The previous state information may indicate state information estimated before time point to. For example, the same information may include channel parameters estimated based on channel information obtained at time point tap. P may be a period (e.g., PMI reporting period) during which channel information is obtained. The current state information may include channel parameters estimated at time point to.

The base station according to various embodiments of the disclosure may obtain current state information, based on the Kalman filter to more correctly predict a multi-dimensional channel state. That is, previous channel state information and current channel state information may be information continuously updated according to an algorithm of the Kalman filter. The current state information according to the Kalman filter may include channel parameters estimated based on prediction from the previous state information and measurement and correction from the channel information obtained from the UE.

According to various embodiments of the disclosure, the base station may generate predicted channel information. The base station may generate the predicted channel information, based on current state information. The current state information indicates up-to-date state information at a current time point, and the predicted channel information indicates information indicating an actual channel state estimated at the current time point. The base station may generate predicted channel information, based on the current state information before next channel information is received. The base station may generate predicted channel information at time point t₀+Δt (<t₁, t₁ indicates a time point at which next channel information is received), based on state information including channel parameters obtained at time point to. In this case, the base station may predict a variance of each channel parameter on a time-frequency resource according to Δt, and generate predicted channel information, based on the predicted variance. For example, based on an equation relating to a channel mode, the base station may generate predicted channel information. The base station may determine predicted channel information using state information according to the Kalman filter. The state information according to the Kalman filter includes low-dimensional channel parameters (e.g., a delay parameter (τ), a Doppler parameter (ν), and a complex weight) (γ_{q})) corresponding to high-dimensional channel states, and thus may reduce complexity in a channel prediction procedure of the base station. In addition, the base station may design a channel model according to a non-linear function configured by the channel parameters, so as to reduce performance degradation of an existing Kalman filter.

According to various embodiments, based on a Kalman filter, the base station may obtain information relating to an LC weight in a previous state together with a rotation matrix. According to an embodiment, the Kalman filter applied by the base station may include at least one of an LKF, an EKF, or a UKF. The Kalman filter applied by the base station and a filtering operation have been described in detail with reference to FIG. 8 and FIG. 9. According to an embodiment, the base station may further obtain an LC weight obtained based on the current state, based on the Kalman filter.

In operation 1620, the base station may obtain predicted channel information. The base station may perform prediction of a LC weight, based on the obtained and filtered LC weight of the current state, the generated rotation matrix, and the information relating to the LC weight in the previous state. According to an embodiment, the base station may perform an operation for CSI reconstruction, based on the predicted LC weight value, and perform downlink transmission, based on the CSI reconstruction. Specifically, the base station may perform CSI reconstruction by performing an LC sum using the filtered LC weight value of the current state and SD/FD basis values.

Although not illustrated in FIG. 16, the base station may configure reconstructed CSI as a statistical prediction value of a predicted channel. In addition, the base station may interpret reported CSI in a current state as a measured value to perform auto-regressive (AR) filtering for information on an extracted secondary statistic.

As described above, the base station may extract information on predicted CSI for each slot through operation 1605 to operation 1620. Although not illustrated in FIG. 16, a base station for channel estimation may further include at least one of some operation shown in FIG. 11 to FIG. 14 as well as the operations described with reference to FIG. 16 for channel prediction based on CSI.

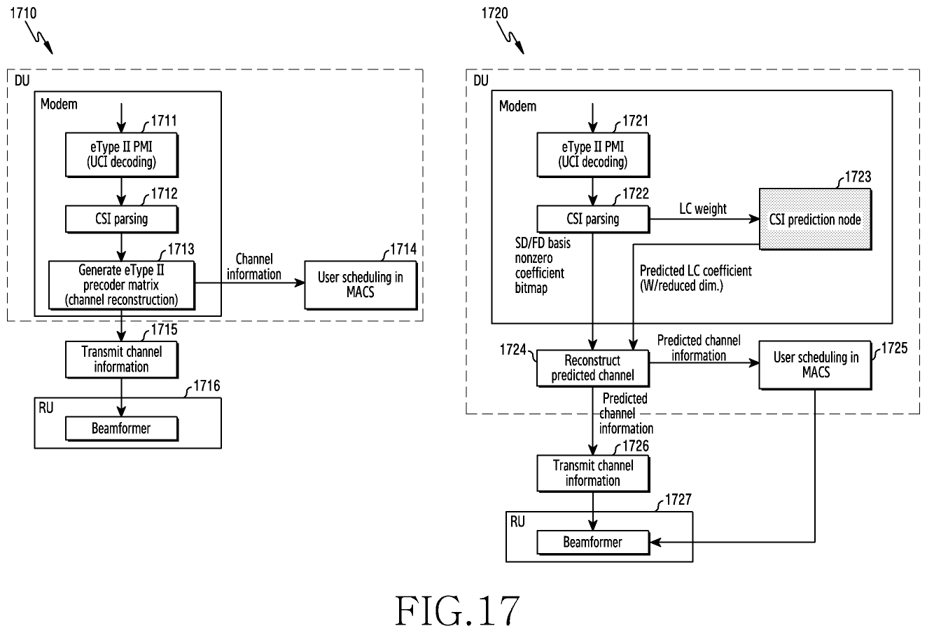

FIG. 17 is a diagram illustrating an example operation for performing a channel prediction operation according to various embodiments.

With reference to FIG. 17, illustrated is a channel prediction structure 1710 where, in a MACS (L2) scheduling block 1714, CSI parsing information is not used and some or entirety of a channel matrix is received from a modem block with respect to an updated CSI report to perform MU scheduling.

In the channel prediction structure 1710, a modem block of a digital unit (DU) may decode UCI (1711) and then perform CSI parsing according to the purpose of each element (1712). The modem block of the DU may perform up to an operation 1713 of generating a channel matrix corresponding to CSI reconstruction based on an eType II PMI. The modem block of the DU may transmit some or entirety of the channel matrix to a scheduling block (L2 MACS) 1714 of the DU, and the scheduling block 1714 of the DU may perform MU scheduling. Thereafter, the modem block of the DU may transmit an updated DL channel matrix 1715 corresponding to reconstructed CSI to a channel memory (not illustrated) of an MMU (RU) block 1716, to update a DL channel matrix from a corresponding slot. The scheduling block 1714 of the DU may transfer a MU-MIMO scheduling result, and an input to enter a DL beamformer may be retrieved from the channel memory.

Referring to FIG. 17, in a channel prediction structure 1720, a model of a DU may further include a CSI prediction block 1723 in addition to the channel prediction structure 1710. The modem block of the DU may decode UCI (1721) and then transmit information related to an LC weight to the CSI prediction block 1723, and the CSI prediction block 1723 may generate a predicted LC weight value having a reduced dimension and transmit same to a block 1724 for CSI reconstruction. The block 1724 for CSI reconstruction may receive an SD/FD basis-related value generated through CSI parsing 1722 and the predicted LC weight value to generate a channel matrix corresponding to CSI reconstruction. Thereafter, the DU may transmit some or entirety of the channel matrix to a scheduling block (L2 MACS) 1725 of the DU, and the scheduling block 1725 of the DU may perform MU scheduling. Thereafter, the DU may transmit an updated DL channel matrix 1726 corresponding to reconstructed CSI to a channel memory (not illustrated) of an MMU (RU) block 1727, to update a DL channel matrix from a corresponding slot. The scheduling block 1725 of the DU may transfer a MU-MIMO scheduling result, and an input to enter a DL beamformer may be retrieved from the channel memory.

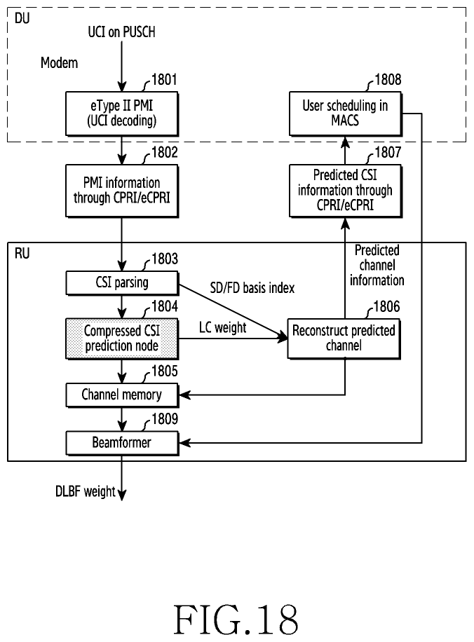

FIG. 18 is a diagram illustrating an example operation for performing a channel prediction operation according to various embodiments of the disclosure. Referring to FIG. 18, illustrated is a channel prediction structure where a compressed CSI prediction node 1804 is included in an RU and a user scheduling block is included in a DU.

Referring to FIG. 18, a modem block of the DU may decode UCI (1801) and then transmit PMI information to the RU through a common public radio interface (CPRI)/enhanced CPR (eCPRI) (1802). The RU may perform CSI parsing, based on the PMI information (1803), and transmit a result therefor to the compressed CSI prediction node 1804. In addition, an SD/FD basis index based on the CSI parsing may be transferred to a block 1806 for predicted channel reconstruction. The compressed CSI prediction node 1804 may generate a predicted LC weight value having a reduced dimension and transfer same to the block 1806 for CSI reconstruction. In addition, the CSI prediction node 1804 may also transfer a corresponding result to a channel memory 1805. The block 1806 for CSI reconstruction may receive the SD/FD basis-related value generated through the CSI parsing 1803 and the predicted LC weight value to generate a channel matrix corresponding to CSI reconstruction. Thereafter, the RU may transfer information on a predicted channel to the DU through a CPRI/eCPRI (1807). In addition, the block 1806 for CSI reconstruction may transmit an updated DL channel matrix 1726 corresponding to reconstructed CSI to the channel memory 1805 of the RU, to update a DL channel matrix from a corresponding slot. A scheduling block (MACS) 1808 of the DU may receive some or the entirety of the predicted channel matrix to perform MU scheduling. Thereafter, the scheduling block 1808 of the DU may transfer a MU-MIMO scheduling result to a beamformer 1809, and an input to enter the DL beamformer may be retrieved from the channel memory.

According to various embodiments of the disclosure, the disclosure is not limited to the structures illustrated in FIGS. 17 and 18, and as long as a structure has the same or similar functions, there may be an individual implementation related to which block among blocks of a DU and a RU in which CSI parsing or DL CSI reconstruction is performed.

According to an embodiment, a channel prediction structure may include a structure in which a modem block of a DU performs CSI parsing and then transmit CSI parsing information to a scheduling block of the DU so as to enable earlier MU-MIMO scheduling at low complexity and thus obtain a scheduling result earlier. CSI reconstruction requires a product operation between matrixes having a large dimension and thus has high complexity and consumes a long time for the operation. However, the above embodiment is advantageous in that the operation complexity is small and a short time is consumed in CSI parsing, and thus MU scheduling is ensured earlier after UCI decoding and CSI parsing is quickly performed.

According to an embodiment, a channel prediction structure may include a structure for transmitting updated channel matrix information generated by performing up to CSI reconstruction from a DU to an RU and transmitting CSI parsing information through a CPRI or eCPRI interface. The updated channel matrix has a large dimension, and thus when the updated channel matrix (e.g., channel information) is transmitted through a CPRI/eCPRI, a large read & write time may be consumed. Therefore, if an RU Li LPHY has a resource on which implementation complexity of CSI reconstruction is handleable, CSI parsing information having a smaller bit overhead is transmitted to the RU through a CPRI/eCPRI, so as to reduce the overall processing time, so that the reduced delay time allows securing of comparatively up-to-date CSI (e.g., less outdated CSI) to contribute to improve MU-MIMO performance.

According to an embodiment, a channel prediction structure may include a structure in which a modem block of a DU performs only up to UCI decoding and an L1 LPHY block in an RU performs a CSI parsing operation and thus performs up to a CSI reconstruction operation. In addition, the above channel prediction structure may include a structure of transferring decoded UCI information from a DU to an RU through a CPRI or eCPRI interface in a forward direction, and transferring CSI parsing information from the RU to a scheduling block of the DU through the CPRI or eCPRI interface in a reverse direction. According to an embodiment, the above channel prediction structure may transmit decoded UCI information from a DU to an RU through a CPRI or eCPRI interface and thus may transfer compressed channel information of a low bit overhead.

As described above, channel prediction structures according to various embodiments including the structures illustrated in FIG. 17 and FIG. 18 may have different characteristics and advantages. Therefore, in view of the entire system design, by comprehensively considering available L1/L2/L1LPHY resources and processing times of a DU and a RU, various design options according to the above embodiments may be selectable.

According to various example embodiments of the disclosure, a method performed by a base station in a wireless communication system may include: obtaining, from a terminal, channel information including current channel state information, based on a channel state information (CSI) report in a first time interval, identifying, based on the channel information, a spatial domain (SD) component, a frequency domain (FD) component, and a linear combination (LC) coefficient value mapped to the SD component and the FD component having been used for compression, obtaining a filtered LC coefficient value, based on a Kalman filter, and generating predicted channel information in a second time interval, based on the SD component, the FD component, and the filtered LC coefficient value.

According to an example embodiment, the method may further include: obtaining a rotation matrix, based on previous channel state information and a correlation between the SD component and the FD component, obtaining a filtered previous LC coefficient value, based on the Kalman filter and the rotation matrix, and generating the predicted channel information in the second time interval, based on the filtered previous LC coefficient value and the filtered LC coefficient value.

According to an example embodiment, the Kalman filter may include at least one of a linear Kalman filter (LKF), an enhanced Kalman filter (EKF), or an unscented Kalman filter (UKF).

According to an example embodiment, the previous channel state information may include information on channel parameters before the first time interval, and the current channel state information may include information on channel parameters in the first time interval.

According to an example embodiment, the channel parameters may include at least one of a Doppler parameter, a delay parameter, or a spatial vector according to an antenna.

According to an example embodiment, the method may further include storing information on the rotation matrix, based on a lookup table (LUT).

According to an example embodiment, the method may further include: identifying a moving speed of the terminal, determining whether a set of the SD component and the FD component is a changing set or a non-changing set, and based on a result of the determining and the moving speed of the terminal, determining whether to obtain the rotation matrix.

According to an example embodiment, the generating of the predicted channel information may include: obtaining a time delay parameter and a Doppler parameter of the current channel state information, and generating the predicted channel information, based on the time delay parameter, the Doppler parameter, and resource difference information.

According to an example embodiment, the SD component may correspond to a matrix related to a spatial beam, the FD component may correspond to a matrix related to a discrete Fourier transform (DFT) vector in a frequency domain, and the LC coefficient value may correspond to a matrix related to a beam angle and time-delay sparsity.

According to an example embodiment, the obtaining of the channel information may include: transmitting a CSI-reference signal (RS) to the terminal and receiving CSI including a precoding matrix indicator (PMI) from the terminal, based on the CSI-RS, the CSI-RS may be periodically transmitted according to period T, and the second time interval may correspond to a time interval before a time interval corresponding to period T after the first time interval.

According to various example embodiments of, a base station in a wireless communication system may include: at least one transceiver, and a controller comprising at least one processor, comprising processing circuitry, coupled to the at least one transceiver, wherein the controller is configured to: obtain, from a terminal, channel information including current channel state information, based on a channel state information (CSI) report in a first time interval, identify, based on the channel information, a spatial domain (SD) component, a frequency domain (FD) component, and a linear combination (LC) coefficient value mapped to the SD component and the FD component having been used for compression, obtain a filtered LC coefficient value, based on a Kalman filter, and generate predicted channel information in a second time interval, based on the SD component, the FD component, and the filtered LC coefficient value.

According to an example embodiment, the controller may be further configured to: obtain a rotation matrix, based on previous channel state information and a correlation between the SD component and the FD component, obtain a filtered previous LC coefficient value, based on the Kalman filter and the rotation matrix, and generate the predicted channel information in the second time interval, based on the filtered previous LC coefficient value and the filtered LC coefficient value.

According to an example embodiment, the Kalman filter may include at least one of a linear Kalman filter (LKF), an enhanced Kalman filter (EKF), or an unscented Kalman filter (UKF).

According to an example embodiment, the previous channel state information may include information on channel parameters before the first time interval, and the current channel state information may include information on channel parameters in the first time interval.

According to an example embodiment, the channel parameters may include at least one of a Doppler parameter, a delay parameter, or a spatial vector according to an antenna.

According to an example embodiment, the controller may be further configured to store information on the rotation matrix, based on a lookup table (LUT).

According to an example embodiment, the controller may be further configured to: identify a moving speed of the terminal, determine whether a set of the SD component and the FD component is a changing set or a non-changing set, and based on a result of the determination and the moving speed of the terminal, determine whether to obtain the rotation matrix.

According to an example embodiment, to generate the predicted channel information, the controller may be configured to: obtain a time delay parameter and a Doppler parameter of the current channel state information, and generate the predicted channel information, based on the time delay parameter, the Doppler parameter, and resource difference information.

According to an example embodiment, the SD component may correspond to a matrix related to a spatial beam, the FD component may correspond to a matrix related to a discrete Fourier transform (DFT) vector in a frequency domain, and the LC coefficient value may correspond to a matrix related to a beam angle and time-delay sparsity.

According to an example embodiment, to obtain the channel information, the controller may be configured to: transmit a CSI-reference signal (RS) to the terminal and receive CSI including a preceding matrix indicator (PMI) from the terminal, based on the CSI-RS, the CSI-RS may be periodically transmitted according to period T, and the second time interval may correspond to a time interval before a time interval corresponding to period T after the first time interval.

It should be noted that the above-described configuration diagrams, illustrative diagrams of control/data signal transmission methods, illustrative diagrams of operation procedures, and structural diagrams are not intended to limit the scope of the disclosure. For example, the elements, entities, or operation steps described in various embodiments of the disclosure should not be construed as being essential elements for the implementation of the disclosure, and even when including only some of the elements, the disclosure may be implemented without impairing the true of the disclosure. Also, the above respective embodiments may be employed in combination, as necessary. For example, the methods described in the disclosure may be partially combined with each other to operate a network entity and a UE.

The above-described operations of a base station or terminal may be implemented by providing any unit of the base station or terminal device with a memory device storing corresponding program codes. For example, a controller of the base station or terminal device may perform the above-described operations by reading and executing the program codes stored in the memory device a processor or central processing unit (CPU).

Various units or modules of an entity, a base station device, or a terminal device may be operated using hardware circuits such as complementary metal oxide semiconductor-based logic circuits, firmware, or hardware circuits such as combinations of software and/or hardware and firmware and/or software embedded in a machine-readable medium. For example, various electrical structures and methods may be implemented using transistors, logic gates, and electrical circuits such as application-specific integrated circuits

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described example embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although various example embodiments have been described in the detailed description of the disclosure, it will be apparent that various modifications and changes may be made thereto without departing from the scope of the disclosure. Therefore, the scope of the disclosure should not be defined as being limited to the various embodiments set forth herein, and include the appended claims and equivalents thereof. That is, it will be apparent to those skilled in the art that other variants based on the technical idea of the disclosure may be implemented. Also, the above respective embodiments may be employed in combination, as necessary. As an example, the methods described in the disclosure may be partially combined with each other to operate a base station and a terminal. Moreover, although the above embodiments have been described based on the 5G or NR system, other variants based on the technical idea of the various embodiments may also be implemented in other communication systems such as LTE, LTE-A, or LTE-A-Pro systems.

What is claimed is:

1. A method performed by a base station in a wireless communication system, the method comprising:
obtaining, from a terminal, channel information including current channel state information, based on a channel state information (CSI) report in a first time interval;
identifying, based on the channel information, a spatial domain (SD) component, a frequency domain (FD) component, and a linear combination (LC) coefficient value mapped to the SD component and the FD component having been used for compression;
obtaining a filtered LC coefficient value, based on a Kalman filter; and
generating predicted channel information in a second time interval, based on the SD component, the FD component, and the filtered LC coefficient value.

2. The method of claim 1, further comprising:
obtaining a rotation matrix, based on previous channel state information and a correlation between the SD component and the FD component;
obtaining a filtered previous LC coefficient value, based on the Kalman filter and the rotation matrix; and
generating the predicted channel information in the second time interval, based on the filtered previous LC coefficient value and the filtered LC coefficient value.

3. The method of claim 2, wherein the Kalman filter comprises at least one of a linear Kalman filter (LKF), an enhanced Kalman filter (EKF), or an unscented Kalman filter (UKF).

4. The method of claim 2, wherein the previous channel state information comprises information on channel parameters before the first time interval, and
wherein the current channel state information comprises information on channel parameters in the first time interval.

5. The method of claim 4, wherein the channel parameters comprise at least one of a Doppler parameter, a delay parameter, or a spatial vector according to an antenna.

6. The method of claim 2, further comprising storing information on the rotation matrix, based on a lookup table (LUT).

7. The method of claim 2, further comprising:
identifying a moving speed of the terminal;
determining whether a set of the SD component and the FD component is a changing set or a non-changing set; and
based on a result of the determining and the moving speed of the terminal, determining whether to obtain the rotation matrix.

8. The method of claim 1, wherein the generating of the predicted channel information comprises:
obtaining a time delay parameter and a Doppler parameter of the current channel state information; and
generating the predicted channel information, based on the time delay parameter, the Doppler parameter, and resource difference information.

9. The method of claim 1,
wherein the SD component corresponds to a matrix related to a spatial beam,
wherein the FD component corresponds to a matrix related to a discrete Fourier transform (DFT) vector in a frequency domain, and
wherein the LC coefficient value corresponds to a matrix related to a beam angle and time-delay sparsity.

10. The method of claim 1, wherein the obtaining of the channel information comprises:
transmitting a CSI-reference signal (RS) to the terminal; and
receiving CSI including a precoding matrix indicator (PMI) from the terminal, based on the CSI-RS,
wherein the CSI-RS is periodically transmitted according to period T, and
wherein the second time interval corresponds to a time interval before a time interval corresponding to period T after the first time interval.

11. A base station in a wireless communication system, the base station comprising:
at least one transceiver; and
a controller coupled to the at least one transceiver, and configured to:
obtain, from a terminal, channel information including current channel state information, based on a channel state information (CSI) report in a first time interval;
identify, based on the channel information, a spatial domain (SD) component, a frequency domain (FD) component, and a linear combination (LC) coefficient value mapped to the SD component and the FD component having been used for compression;
obtain a filtered LC coefficient value, based on a Kalman filter, and
generate predicted channel information in a second time interval, based on the SD component, the FD component, and the filtered LC coefficient value.

12. The base station of claim 11, wherein the controller is further configured to:
obtain a rotation matrix, based on previous channel state information and a correlation between the SD component and the FD component;
obtain a filtered previous LC coefficient value, based on the Kalman filter and the rotation matrix; and
generate the predicted channel information in the second time interval, based on the filtered previous LC coefficient value and the filtered LC coefficient value.

13. The base station of claim 12, wherein the Kalman filter comprises at least one of a linear Kalman filter (LKF), an enhanced Kalman filter (EKF), or an unscented Kalman filter (UKF).

14. The base station of claim 12, wherein the previous channel state information comprises information on channel parameters before the first time interval, and
wherein the current channel state information comprises information on channel parameters in the first time interval.

15. The base station of claim 14, wherein the channel parameters comprise at least one of a Doppler parameter, a delay parameter, or a spatial vector according to an antenna.

16. The base station of claim 12, wherein the controller is further configured to store information on the rotation matrix, based on a lookup table (LUT).

17. The base station of claim 12, wherein the controller is further configured to:
identify a moving speed of the terminal,
determine whether a set of the SD component and the FD component is a changing set or a non-changing set, and
based on a result of the determining and the moving speed of the terminal, determine whether to obtain the rotation matrix.

18. The base station of claim 11, wherein, in order to generate the predicted channel information, the controller is configured to:
obtain a time delay parameter and a Doppler parameter of the current channel state information, and
generate the predicted channel information, based on the time delay parameter, the Doppler parameter, and resource difference information.

19. The base station of claim 11,
wherein the SD component corresponds to a matrix related to a spatial beam,
wherein the FD component corresponds to a matrix related to a discrete Fourier transform (DFT) vector in a frequency domain, and
wherein the LC coefficient value corresponds to a matrix related to a beam angle and time-delay sparsity.

20. The base station of claim 11, wherein, in order to obtain the channel information, the controller is further configured to:
transmit a CSI-reference signal (RS) to the terminal, and
receive CSI including a precoding matrix indicator (PMI) from the terminal, based on the CSI-RS,
wherein the CSI-RS is periodically transmitted according to period T, and
wherein the second time interval corresponds to a time interval before a time interval corresponding to period T after the first time interval.
